(19) United States
(12) Patent Application Publication
(10) Pub. No.: US 2026/0118174 A1
(43) Pub. Date: Apr. 30, 2026

(54) SPECTROSCOPIC APPARATUS COMPRISING A TUNABLE LIGHT SOURCE

(71) Applicant: Teknologian tutkimuskeskus VTT Oy, Espoo (FI)

(72) Inventors: Teemu KÄÄRIÄINEN, Espoo (FI); Jussi SOUKKAMÄKI, Espoo (FI)

(73) Assignee: Teknologian tutkimuskeskus VTT Oy, Espoo (FI)

(21) Appl. No.: 19/163,906

(22) PCT Filed: Oct. 15, 2024
(86) PCT No.: PCT/FI2024/050548

§ 371 Date: Sep. 10, 2025

(30) Foreign Application Priority Data
Oct. 25, 2023 (FI) 20236191

(51) Int. Cl. G01J 3/02; G01J 3/10; G01J 3/26; G01J 3/28

(52) U.S. Cl. CPC G01J 3/027; G01J 3/0297; G01J 3/10; G01J 3/26; G01J 3/2823; G01J 2003/102

(57) ABSTRACT

A spectroscopic apparatus includes:
an illuminating unit to generate light pulses at selectable wavelengths,
a control unit to control operation of the illuminating unit,
   wherein the illuminating unit includes:
a broadband light source to generate broadband light pulses,
a tunable Fabry-Perot interferometer to form narrowband light pulses by filtering the broadband light pulses,
   wherein the control unit is arranged to:
modulate the mirror gap of the Fabry-Perot interferometer according to a periodic modulating waveform,
trigger a first broadband light pulse at a first trigger time so as to form a first narrowband light pulse at a first wavelength,
trigger a second broadband light pulse at a second trigger time so as to form a second narrowband light pulse at a second wavelength.

### FIELD

The aspects of the disclosed embodiments relate to an apparatus, which is arranged to form light pulses at selectable wavelengths.

### BACKGROUND

A known hyperspectral imaging system comprises a broadband light source to illuminate an object, and a spectrally selective camera to capture spectral images of the object.

### SUMMARY

The aspects of the disclosed embodiments are directed to an apparatus, which comprises a tunable light source. The aspects of the disclosed embodiments are also directed to a method for forming pulsed light at selectable wavelengths. The aspects of the disclosed embodiments are directed to a spectrometer. The aspects of the disclosed embodiments are directed to a method for measuring a spectral property of a sample. The aspects of the disclosed embodiments are directed to a spectral imaging apparatus. The aspects of the disclosed embodiments are directed to a method for spectral imaging.

According to an aspect, there is provided an apparatus (500), comprising:
an illuminating unit (110) to generate light pulses (B2) at selectable wavelengths (λ₁, λ₂),
a control unit (CNT1) to control operation of the illuminating unit (110),
   wherein the illuminating unit (110) comprises:
a broadband light source (LS1) to generate broadband light pulses (B1),
a tunable Fabry-Perot interferometer (FPI1) to form narrowband light pulses (B2) by filtering the broadband light pulses (B1),
   wherein the control unit (CNT1) is arranged to:
modulate the mirror gap (d_{GAP}) of the Fabry-Perot interferometer (FPI1) according to a periodic modulating waveform (S_{GAP}(t)),
trigger a first broadband light pulse (B1) at a first trigger time (t₁), so as to form a first narrowband light pulse (B2) at a first wavelength (λ₁),
trigger a second broadband light pulse (B1) at a second trigger time (t₂), so as to form a second narrowband light pulse (B2) at a second wavelength (λ₂),
   wherein the first trigger time (t₁) is associated with a first value (S_{GAP, 1}) of the modulating waveform (S_{GAP}(t)),
   wherein the second trigger time (t₂) is associated with a second different value (S_{GAP, 2}) of the modulating waveform (S_{GAP}(t)).

The scope of protection sought for various embodiments of the disclosed subject matter is set out by the independent claims. The embodiments, if any, described in this specification that do not fall under the scope of the independent claims are to be interpreted as examples useful for understanding various embodiments of the invention.

The apparatus comprises an illuminating unit to form illuminating light pulses at different wavelengths. The apparatus may be a spectroscopic apparatus, i.e. an apparatus, which is suitable for measuring one or more spectral properties of an object. The illuminating unit comprises a broadband light source, a Fabry-Perot interferometer, and a control unit. The broadband light source may generate broadband light pulses. The Fabry-Perot interferometer may form narrowband light pulses by filtering the broadband light pulses. The control unit may control operation of the broadband light source and the Fabry-Perot interferometer.

The illuminating unit may be arranged to form narrowband light pulses at several different wavelengths. The wavelengths and the number of the wavelengths may be freely selected by a user. The mirror gap of the Fabry-Perot interferometer may be modulated according to a modulating waveform. The apparatus may form a narrowband light pulse at a selected wavelength by controlling the timing of a broadband light pulse with respect to a reference point of the modulating waveform. The wavelength may be changed by changing the timing of the light pulses. Each different wavelength may correspond to a different time delay between a reference time and a triggered broadband light pulse.

The mirror gap of the Fabry-Perot interferometer may be modulated rapidly, so as to allow forming each narrowband light pulse at an individually selectable wavelength. The mirror gap may be varied e.g. as a sinusoidal function of time. The frequency of the waveform may be e.g. greater than 10 kHz. The repetition rate of the narrowband light pulses may be e.g. greater than 10 KHz.

The control unit may be arranged to control the timing of the light pulses, so as to form the narrowband light pulses at the desired wavelengths. The desired wavelengths may be specified e.g. by a sequence of control values. The control unit may be arranged to control the timing of the light pulses according to the sequence of control values. The apparatus may comprise a memory for storing the sequence of control values. The sequence of control values may be retrieved from the memory during operation.

The light pulses may be generated at an average pulse repetition rate f₀. The mirror gap of the Fabry-Perot interferometer may be modulated at a modulation frequency f_{SCAN}. The mirror gap may be varied e.g. according to a sinusoidal waveform, which has the modulation frequency f_{SCAN}. The modulation frequency f_{SCAN} may be e.g. higher than or equal to the average pulse repetition rate f₀.

The wavelength of each narrowband light pulse may be freely selected in a situation where the modulation frequency is matched with the average repetition rate of the narrowband light pulses. In an embodiment, the wavelength of each narrowband light pulse may be freely selected from the whole spectral operating range of the Fabry-Perot interferometer.

The duration of the individual light pulses may be short when compared with the modulation time period T_{SCAN}. The duration of the individual light pulses may be e.g. shorter than 1% of the modulation time period T_{SCAN}. Consequently, the spectral width of the narrowband light pulses may be substantially equal to the spectral width of the transmittance peak of the Fabry-Perot interferometer.

The mirror gap may be modulated according to a modulating waveform, at a constant frequency. The broadband light pulses may be emitted at specific instances during the modulation of the mirror gap. The wavelength of each narrowband light pulse may be determined by the timing of the broadband light pulses. The method may allow accurate control of the wavelength at high repetition rate of the light pulses.

The actuating mechanism of the Fabry-Perot interferometer may have one or more mechanical resonance frequencies. Varying the mirror gap according to the constant modulation frequency may facilitate stable and reliable operation of the Fabry-Perot interferometer. When operating at high modulating frequencies, a rapid change of the modulation frequency may involve a risk of unexpected behavior. When operating near a mechanical resonating frequency, a rapid change of the modulation frequency may even involve a risk of damaging the Fabry-Perot interferometer, e.g. if the mirrors collide with each other or if the amplitude of the movement of a mirror becomes too large.

The control unit may form e.g. a substantially sinusoidal modulating signal for the Fabry-Perot interferometer, and the control unit may form trigger signals for timing the light pulses of the broadband light source. The trigger signals control the timing of the broadband light pulses, and also the timing of the narrowband light pulses.

The broadband light source may be e.g. a pulsed supercontinuum light source. The broadband light source may comprise a laser light source to generate monochromatic primary light pulses, and an optical fiber to form broadband light pulses from the primary light pulses. The laser light source may be e.g. a master oscillator power amplifier (MOPA). The master oscillator power amplifier comprises a seed laser and an optical amplifier to boost the output power. The control unit may form trigger signals for timing the laser pulses of a seed laser of the broadband light source. The timing of the laser light pulse of the seed laser can be controlled with high speed and with high accuracy. The broadband light source may be arranged to generate light pulses at an average repetition rate f₀. The average time period T₀ between consecutive light pulses of the broadband light source is equal to 1/f₀. The amplification coefficient of the optical amplifier may depend on the time intervals between consecutive light pulses. A time interval between consecutive light pulses may deviate from the average time period T₀ according to the timing of the light pulses. The optical amplifier may allow a deviation, which is e.g. smaller than or equal to ±10% of the average time period T₀. Variation of the energy of the light pulses may be within an acceptable range e.g. in a situation where the time intervals between consecutive light pulses are e.g. in the range of 80% to 120% of the average time period T₀.

The modulation frequency f_{SCAN} of the mirror gap may also be e.g. greater than or equal to two times the base frequency f₀ of the broadband light source, so as to allow reducing the relative deviation of the time interval between consecutive light pulses, and allowing the freedom to select the wavelengths of the narrowband light pulses from the full spectral range of the Fabry-Perot interferometer.

The apparatus may be arranged to generate at most one broadband light pulse during a half period of the modulating waveform of the Fabry-Perot interferometer.

A spectral imaging apparatus may comprise the illuminating unit to illuminate an object with the narrowband light pulses. The spectral imaging apparatus may comprise an imaging unit to capture spectral images of the illuminated object. The imaging unit may be arranged to capture images of the object at a rate, which may be e.g. equal to the average repetition rate of the illuminating narrowband light pulses.

### BRIEF DESCRIPTION OF THE DRAWINGS

In the following examples, several variations will be described in more detail with reference to the appended drawings, in which

FIG. 1a shows, by way of example, in a cross-sectional side view, a Fabry-Perot interferometer,

FIG. 1b shows, by way of example, a spectral transmittance function of the Fabry-Perot interferometer,

FIG. 1c shows, by way of example, a spectral imaging apparatus, which comprises a tunable illuminating unit,

FIG. 2a shows, by way of example, a light source to generate broadband light pulses,

FIG. 2b shows, by way of example, spectral intensity distribution of broadband light pulses,

FIG. 2c shows, by way of example, spectral transmittance function of the Fabry-Perot interferometer,

FIG. 2d shows, by way of example, spectral intensity distribution of a narrowband light pulse,

FIG. 3a shows, by way of example, a sequence of generated narrowband light pulses,

FIG. 3b shows, by way of example, time intervals between consecutive light pulses,

FIG. 3c shows, by way of example, reference pulses formed by a reference detector of the illuminating unit,

FIG. 4a shows, by way of example, forming a sequence of narrowband light pulses at selectable wavelengths,

FIG. 4b shows, by way of example, forming a sequence of narrowband light pulses at selectable wavelengths,

FIG. 4c shows, by way of example, forming a sequence of narrowband light pulses at selectable wavelengths,

FIG. 4d shows, by way of example, a triangular modulating waveform,

FIG. 5a shows, by way of example, a Fabry-Perot interferometer, which is arranged to operate in a vacuum chamber,

FIG. 5b shows, by way of example, a Fabry-Perot interferometer, which is arranged to operate in a vacuum chamber,

FIG. 6a shows, by way of example, an arrangement for calibrating the spectral scale of the Fabry-Perot interferometer,

FIG. 6b shows, by way of example, associating control signal values with wavelengths by using calibration detectors,

FIG. 6c shows, by way of example, measuring the mirror gap by using a capacitive sensor,

FIG. 7a shows, by way of example, measuring spectral data by using a non-imaging spectrometer,

FIG. 7b shows, by way of example, capturing spectral images with a spectral imaging apparatus,

FIG. 8a shows, by way of example, capturing a linear spectral image with a spectral imaging apparatus,

FIG. 8b shows, by way of example, capturing linear spectral images with a spectral imaging apparatus,

FIG. 9a shows, by way of example, capturing spectral images by forming a single light pulse during a single exposure time,

FIG. 9b shows, by way of example, capturing a spectral image by forming several light pulses during an extended exposure time,

FIG. 9c shows, by way of example, providing a selectable effective spectral width by forming several light pulses at different wavelengths,

FIG. 9d shows, by way of example, forming narrowband light pulses, which together correspond to a spectral energy distribution,

FIG. 10a shows, by way of example, an illuminating unit, which comprises optical filters for selecting different orders of interference of the Fabry-Perot interferometer, and

FIG. 10b shows, by way of example, using optical filters for selecting different orders of interference of the Fabry-Perot interferometer.

### DETAILED DESCRIPTION

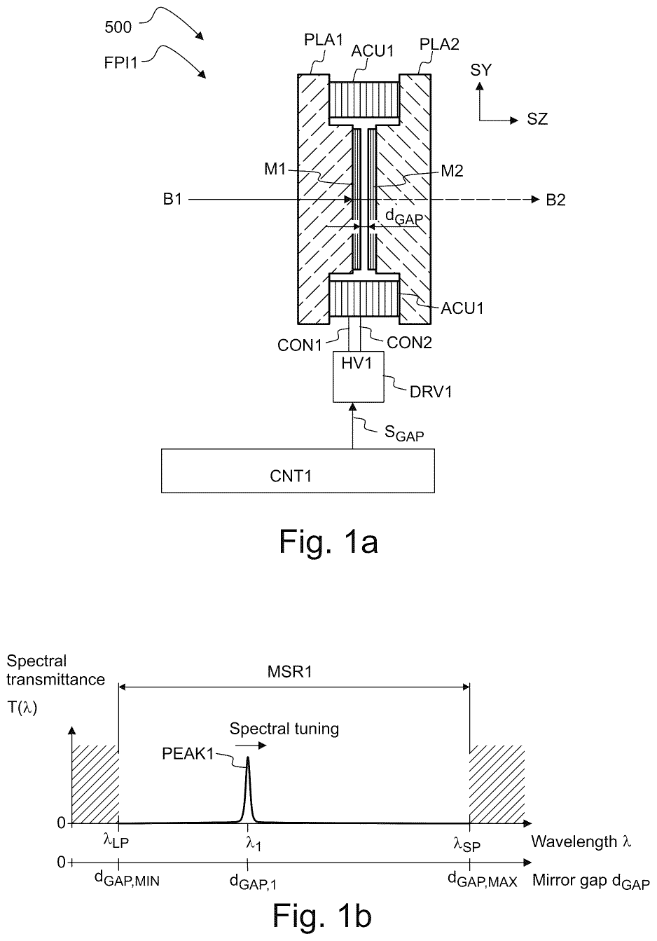

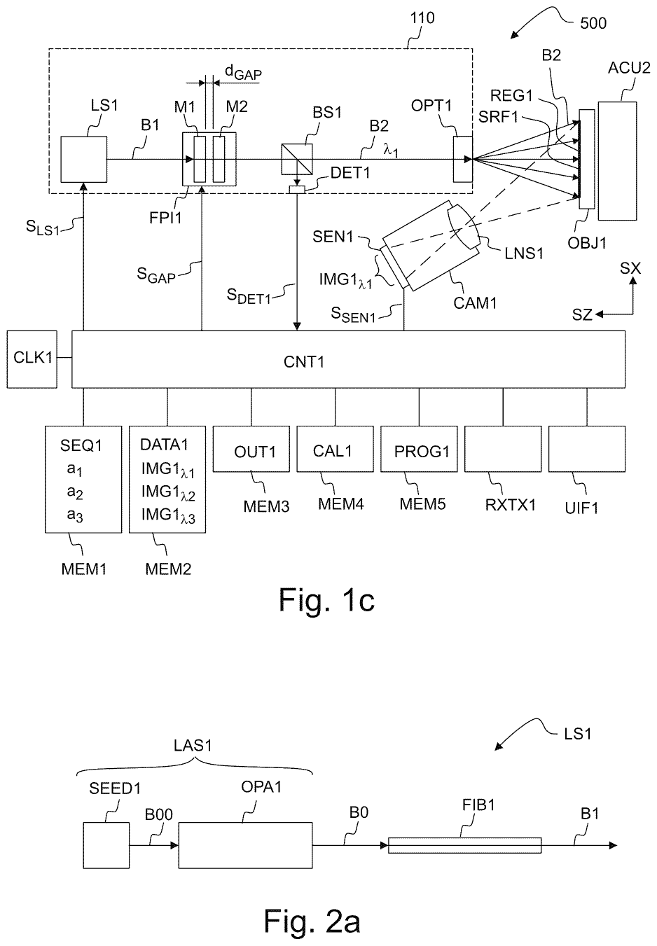

Referring to FIG. 1a, the apparatus 500 comprises a Fabry-Perot interferometer FPI1 to form narrowband light pulses B2 from broadband light pulses B1. The Fabry-Perot interferometer FPI1 forms the narrowband light pulses B2 by optically filtering the broadband light pulses B1.

The Fabry-Perot interferometer FPI1 comprises a first semi-transparent mirror M1 and a second semi-transparent mirror M2. The first mirror M1 is parallel with the second mirror M2. The mirror gap d_{GAP} between the mirrors M1, M2 is adjustable. The mirror gap d_{GAP} means the distance between the mirrors M1, M2. The wavelength λ of the spectral transmittance peak PEAK1 of the Fabry-Perot interferometer FPI1 depends on the mirror gap d_{GAP}. The wavelength λ of the spectral transmittance peak PEAK1 of the Fabry-Perot interferometer FPI1 may be changed by changing the mirror gap d_{GAP}. The wavelength λ of each narrowband light pulse B2 is determined by the mirror gap d_{GAP} of the Fabry-Perot interferometer FPI1.

The Fabry Perot interferometer FPI1 comprises one or more actuators ACU1 for changing the mirror gap d_{GAP}. The actuator ACU1 may be e.g. a piezoelectric actuator or an electrostatic actuator. At least one of the mirrors M1, M2 may be moved by the one or more actuators ACU1. The first mirror M1 may be implemented e.g. on a first mirror plate PLA1. The second mirror M2 may be implemented e.g. on a second mirror plate PLA2.

The apparatus 500 comprises a control unit CNT1 for controlling operation of the Fabry-Perot interferometer FPI1. The control unit CNT1 may form a modulating control signal S_{GAP} for changing the mirror gap d_{GAP}. The modulating signal S_{GAP} has a modulating waveform. The apparatus 500 may be arranged to change the mirror gap d_{GAP} according to the modulating waveform of the signal S_{GAP}. The modulating signal S_{GAP} may have e.g. sinusoidal or triangular waveform.

The control unit CNT1 may provide e.g. a digital modulating signal S_{GA}P. The apparatus 500 may comprise a driving unit DRV1 to form an analog driving signal HV1 for driving the one or more actuators ACU1. The driving unit DRV1 may e.g. convert a digital modulating signal S_{GAP} e.g. into an analog voltage signal HV1 for driving the one or more actuators ACU1. The analog driving signal HV1 may be coupled from the driving unit DRV1 to an actuator ACU1 e.g. via conductors CON1, CON2.

SX, SY, and SZ Denote Orthogonal Directions.

Referring to FIG. 1b, the spectral transmittance function T(λ) of the Fabry-Perot interferometer FPI1 has a spectral transmittance peak PEAK1. The spectral position λ_{PEAK1} of the spectral transmittance peak PEAK1 depends on the mirror gap d_{GAP}. For example, a first wavelength λ₁ may correspond to a mirror gap value d_{GAP, 1}. The wavelength of narrowband light pulses B2 transmitted through the Fabry-Perot interferometer may also be equal to said first wavelength λ₁ when the mirror gap d_{GAP} is equal to the value d_{GAP, 1}. The spectral position of the spectral transmittance peak PEAK1 may be changed by changing the mirror gap d_{GAP}. The wavelength of the narrowband light pulses B2 may be changed by changing the mirror gap d_{GAP}.

The Fabry-Perot interferometer may have a spectral operating range MSR1. The spectral operating range MSR1 may also be called e.g. as the spectral measurement range. The spectral operating range MSR1 may have a lower cut-off wavelength λ_{LP} and an upper cut-off wavelength λ_{SP}. The spectral operating range MSR1 may be defined e.g. by one or more optical filters FIL1, FIL2. For example, the lower cut-off wavelength λ_{LP} may correspond to a minimum value d_{GAP, MIN} of the mirror gap, and the upper cut-off wavelength λ_{SP} may correspond to a maximum value d_{GAP, MAX} of the mirror gap.

The spectral apparatus 500 may optionally comprise one or more optical filters to define the spectral operating range MSR1, so that the spectral transmittance function T(λ) of the Fabry-Perot interferometer FPI1 may have only one spectral transmittance peak PEAK1 at a time.

Referring to FIG. 1c, the spectral apparatus 500 comprises an illuminating unit 110 to form narrowband light pulses B2 at different individually selectable wavelengths λ₁, λ₂, λ₃. The illuminating unit 110 comprises a broadband light source LS1 to form broadband light pulses B1, and a Fabry-Perot interferometer FPI1 to form the narrowband light pulses from the broadband light pulses B1.

The apparatus 500 comprises a control unit CNT1 to control operation of the illuminating unit 110. The control unit CNT1 may control operation of the broadband light source LS1, and to control operation of the Fabry-Perot interferometer FPI1. The control unit CNT1 may comprise one or more data processors. The control unit may comprise e.g. a field-programmable-gate array (FPGA). The illuminating unit 110 may comprise the control unit CNT1.

The control unit CNT1 may form a trigger signal S_{LS1} for triggering emission of broadband light pulses B1. The control unit CNT1 may form a modulating waveform S_{GAP} for modulating the mirror gap d_{GAP} of the Fabry-Perot interferometer FPI1.

The control unit CNT1 modulates the transmission wavelength λ of the Fabry-Perot interferometer FPI1 by modulating the mirror gap d_{GAP}. The mirror gap d_{GAP} is modulated according to a periodic modulating waveform S_{GAP}(t). The wavelength of each narrowband light pulse B2 may be determined by the timing of a broadband light pulse B1 with respect to the modulating waveform S_{GAP}(t). The control unit CNT1 may control the timing of the broadband light pulses B1, so as to form narrowband light pulses B2 at desired wavelengths λ₁, λ₂, λ₃. The wavelengths λ₁, λ₂, λ₃ may be freely selectable from the spectral operating range MSR1 of the Fabry-Perot interferometer FPI1.

The broadband light source LS1 may be arranged to generate a broadband light pulse B1 according to a trigger signal S_{LS1} formed by the control unit CNT1. The trigger signal S_{LS1} may control the time of emission of a broadband light pulse B1. The timing of a broadband light pulse B1 may be determined according to the trigger signal S_{LS1}. The trigger signal S_{LS1} may also control whether the broadband light pulse B1 is emitted or not. The broadband light source LS1 may be arranged to generate a broadband light pulse B1 only when instructed by the trigger signal S_{LS1} to do so.

The apparatus 500 may comprise a clock CLK1 for measuring the lengths of time intervals and for forming timing signals. The control unit CNT1 may synchronize triggering of the light pulses B1 with the modulating waveform S_{GAP}(t) by using the clock CLK1.

The illuminating unit 110 may be arranged to illuminate an object OBJ1 with the narrowband light pulses B2. The narrowband light pulses B2 may illuminate a region REG1 of the object OBJ1. The narrowband light pulses B2 may illuminate a region REG1 of the surface SRF1 of the object OBJ1. The illuminating unit 110 may optionally comprise illuminating optics OPT1 e.g. to focus or distribute the narrowband light pulses B2 to a desired region of the object OBJ1.

The apparatus 500 may optionally comprise an imaging unit CAM1 to capture spectral images IMG1_{λ1}, IMG1_{λ2}, IMG1_{λ3}, of one or more illuminated regions REG1 of the object OBJ1. The imaging unit CAM1 may comprise imaging optics LNS1 and an image sensor SEN1. The image sensor SEN1 may form a sensor signal S_{SEN1}. The sensor signal S_{SEN1} may comprise e.g. a captured image IMG1_{λ1}. A first spectral image IMG1_{λ1} may be captured when the object is illuminated with a first narrowband pulse B2, which has a first wavelength λ₁. A second spectral image IMG1_{λ2} may be captured when the object is illuminated with a second narrowband pulse B2, which has a second wavelength λ₂. A third spectral image IMG1_{λ3} may be captured when the object is illuminated with a third narrowband pulse B2, which has a third wavelength λ₃. The apparatus 500 may comprise a memory MEM2 for storing data DATA1 obtained from the sensor SEN1. The sensor data DATA1 may comprise e.g. captured images IMG1_{λ1}, IMG1_{λ2}, IMG1_{λ3}.

The illuminating unit 110 may be used together with the image sensor SEN1 for hyperspectral imaging. The spectral selectivity may be provided by the spectrally selective illumination.

The illuminating unit 110 may be used e.g. together with a 1D or 2D image sensor SEN1 for hyperspectral imaging. The image sensor may also be panchromatic, i.e. all detector pixels of the image sensor may have similar spectral response. The detector pixels of the 1D image sensor are arranged in a one-dimensional array. The detector pixels of the 2D image sensor are arranged in a two-dimensional array.

The illuminating unit 110 may be arranged to illuminate an object OBJ1 in a spectrally selective manner. The object OBJ1 may also be called e.g. as a sample or as a target.

The wavelength of each narrowband light pulse B2 can be selected individually, by periodically varying the mirror gap d_{GAP} of the Fabry-Perot interferometer FPI1 and by selecting the timing of the broadband light pulses B1 according to values a₁, a₂, a₃, . . . of a control sequence SEQ1. The control sequence SEQ1 may comprise e.g. at least 2, 3, 4, 5, 6, 7, 8, 9, or 10 individually selectable control values a₁, a₂, a₃, . . . The apparatus 500 may form a corresponding sequence of narrowband light pulses B2 according to the control sequence SEQ1. The sequence of pulses may comprise e.g. at least 2, 3, 4, 5, 6, 7, 8, 9, or 10 narrowband light pulses B2 at individually selectable wavelengths.

The apparatus 500 may be arranged to form the narrowband light pulses B2 according to the selectable values a₁, a₂, a₃, . . . of the control sequence SEQ1. The apparatus 500 may comprise a memory MEM1 for storing the control sequence SEQ1. The values a₁, a₂, a₃, . . . of the control sequence SEQ1 may be retrieved from the memory MEM1 for forming the narrowband light pulses B2 at the desired wavelengths λ₁, λ₂, λ₃ of the narrowband light pulses B2. The values a₁, a₂, a₃, . . . may e.g. specify the desired wavelengths λ₁, λ₂, λ₃ of the narrowband light pulses B2. The first value a₁ may be indicative of the target wavelength (λ₁) of the first narrowband light pulse B2. The second value a₂ may be indicative of the target wavelength (λ₂) of the second narrowband light pulse B2. The third value a₃ may be indicative of the target wavelength (λ₃) of the third narrowband light pulse B2.

The control unit CNT1 may control timing of the broadband light pulses B1 according to the control sequence SEQ1, so as to form the narrowband light pulses B2 at the wavelengths λ₁, λ₂, λ₃.

In an embodiment, the sequence SEQ1 of control values a₁, a₂, a₃, . . . may also be changed in real time during operation.

The control unit CNT1 may be optionally arranged to determine output values OUT1 from the captured spectral images. For example, the control unit CNT1 may calculate spectral reflectance values of the object OBJ1 or spectral transmittance values of the object OBJ1 from pixel values of the captured images IMG1_{λ1}, IMG1_{λ2}, IMG1_{λ3}. The output values OUT1 may be e.g. spectral reflectance values or spectral transmittance values. The apparatus 500 may comprise a memory MEM3 for storing the output values OUT1.

The control unit CNT1 may determine the output values OUT1 by using calibration data CAL1. For example, the control unit CNT1 may be configured to determine spectral reflectance values from pixel values of a captured spectral image (IMG1_{λ1}) by using calibration data CAL1. The apparatus 500 may comprise a memory MEM4 for storing calibration data CAL1.

The control unit CNT1 may perform the steps of the present method by executing computer program code PROG1. The apparatus 500 may comprise a memory MEM5 for storing the computer program code PROG1.

The apparatus 500 may optionally comprise a communication unit RXTX1 receiving and/or transmitting data. The communication unit RXTX1 may communicate e.g. via wired and/or wireless communication. The communication unit RXTX1 may communicate e.g. via a mobile communications network. For example, the communication unit RXTX1 may communicate data DATA1 and/or output values OUT1 to a remote device. The communication unit RXTX1 may communicate e.g. with a control unit of an industrial manufacturing process.

The apparatus 500 may optionally comprise a user interface UIF1 for receiving user input and/or for providing information to user. The user interface UIF1 may comprise e.g. touchscreen and/or a keypad.

The apparatus 500 may comprise:
an illuminating unit 110 to illuminate a region REG1 of an object OBJ1 with a narrowband light pulse B2, and
a camera CAM1 to capture a spectral image IMG1_{λ} of the illuminated region REG1,
   wherein the illuminating unit 110 comprises:
a light source LS1 to generate broadband light pulses B1,
a tunable Fabry-Perot interferometer FPI1 to form the narrowband light pulse B2 by filtering a broadband light pulse B1, wherein the wavelength (λ) of the illuminating light pulse B2 is determined by the mirror gap d_{GAP} of the Fabry-Perot interferometer FPI1,
   wherein the apparatus 500 is arranged to change the mirror gap d_{GAP} of the Fabry-Perot interferometer FPI1.

The control unit CNT1 may be arranged trigger a first broadband light pulse B1 at a first time t₁ when the periodically modulated mirror gap has a first value d_{GAP, 1}, so as to form a first narrowband light pulse B2 which has a first wavelength (λ₁). The imaging unit CAM1 may be arranged to capture an image IMG1_{λ1} of the object OBJ1 when the object OBJ1 is illuminated with the first narrowband light pulse (B2). The control unit CNT1 may be arranged trigger a second broadband light pulse B1 at a second time t₂ when the periodically modulated mirror gap has a second value d_{GAP, 2}, so as to form a second narrowband light pulse B2 which has a second wavelength λ₂. The imaging unit CAM1 may be arranged to capture an image IMG1_{λ2} of the object OBJ1 when the object OBJ1 is illuminated with the second narrowband light pulse B2.

The illuminating unit 110 may illuminate a region REG1 of the object OBJ1 with a first narrowband light pulse B2_{λ1}, which has a first wavelength λ₁ at a time t₁. The field-of-view FOV1 of the imaging unit CAM1 overlaps illuminated region REG1. The imaging unit CAM1 may capture a first spectral image IMG1_{λ1} of the illuminated region REG1 when the object OBJ1 is illuminated with the first narrowband light pulse B2_{λ1}. The captured spectral image IMG1_{λ1} may represent the first wavelength λ₁.

The illuminating unit 110 may illuminate a region REG1 of the object OBJ1 with a second narrowband light pulse B2_{λ2}, which has a second wavelength λ₂ at a time t₂. The imaging unit CAM1 may capture a second spectral image IMG1_{λ2} of the illuminated region REG1 when the object OBJ1 is illuminated with the second narrowband light pulse B2_{λ2}. The captured spectral image IMG1_{λ2} may represent the second wavelength λ₂.

The illuminating unit 110 may illuminate a region REG1 of the object OBJ1 with a third narrowband light pulse B2_{λ3}, which has a third wavelength λ₃ at a time t₃. The imaging unit CAM1 may capture a third spectral image IMG1_{λ3} of the illuminated region REG1 when the object OBJ1 is illuminated with the third narrowband light pulse B2_{λ3}. The captured spectral image IMG1_{λ3} may represent the third wavelength λ₃.

In an embodiment, at least one spectral image IMG1_{λ1}, IMG_{λ2} may be captured by illuminating the object OBJ1 with only one narrowband light pulse B2. At least one spectral image IMG1_{λ1}, IMG_{λ2} may be captured by illuminating the object OBJ1 with a single wavelength.

The illuminating unit 110 may be arranged to generate a plurality of narrowband light pulses B2 at different wavelengths λ₁, λ₂, . . . by changing the mirror gap d_{GAP} according to a modulating waveform. The movement of the moving mirror M2 of the Fabry-Perot interferometer FPI1 may be stopped at least once between each narrowband light pulse and the next narrowband light pulse.

The apparatus 500 may also be arranged to optionally capture one or more dark image frames, e.g. for compensating background illumination and/or for compensating sensor noise. A dark image may be captured e.g. such that the illuminating unit 110 does not emit a narrowband light pulse B2 during an exposure time Δt_{EX} of the sensor SEN1. The imaging unit CAM1 may be arranged to capture a dark image when the object OBJ1 is not illuminated with a narrowband light pulse B2, or when the wavelength (λ) of an illuminating narrowband light pulse B2 is outside the spectral detection range of the imaging unit CAM1.

The illuminating unit 110 may optionally comprise a beam splitter BS1, and a reference detector DET1, wherein a part of the light of the light pulses B1, B2 may be directed to the reference detector DET1 via the beam splitter BS1 so as to measure the energy and/or intensity of the light pulses B1, B2.

The apparatus 500 may optionally comprise an actuator ACU2 for causing relative movement between the illuminating unit 110 and the object OBJ1. The actuator ACU2 may comprise e.g. conveyor belt and/or a robot. The actuator ACU2 may also change angular orientation of the apparatus 500 with respect to the object OBJ1. The actuating unit ACU2 may be e.g. a turret, which may be arranged to rotate the apparatus 500 with respect to a stationary object OBJ1.

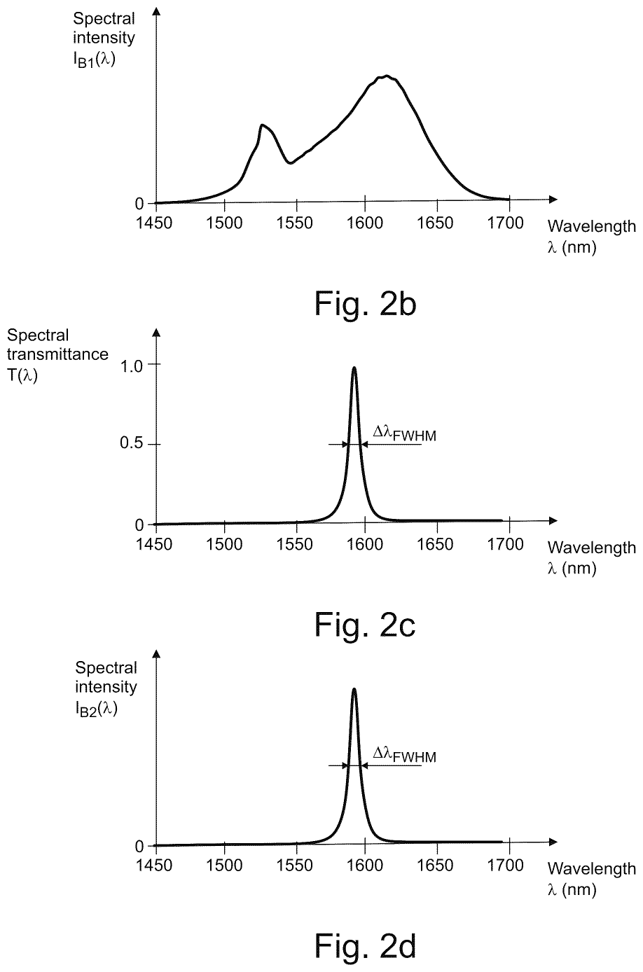

Referring to FIG. 2a, the broadband light source LS1 may be e.g. a pulsed supercontinuum light source. The broadband light source may comprise a laser light source LAS1 to generate monochromatic primary light pulses B0, and an optical fiber FIB1 to form broadband light pulses B1 from the primary light pulses B0. The laser light source LAS1 may be e.g. a master oscillator power amplifier (MOPA). The master oscillator power amplifier comprises a seed laser SEED1 and an optical amplifier OPA1 to boost the output power. The timing of the laser light pulse B00 of the seed laser SEED1 can be controlled with high speed and with high accuracy.

The laser light source LAS1 may form monochromatic primary light pulses B0. The optical fiber FIB1 may form broadband light pulses B1 by spectrally broadening the spectral bandwidth of the primary light pulses B0. The laser light source LAS1 may emit monochromatic primary laser pulses B0, which have high peak power. The spectrum of the monochromatic primary pulses B0 is broadened due to non-linear effects in an optical fiber. The maximum power of the primary pulses B0 may be e.g. greater than 10 KW. The duration Δt_{DUR} of the generated light pulses B0, B1, B2 may be e.g. shorter than 3 ns.

The average repetition rate f₀ of the light pulses B0, B1, B2 may be e.g. greater than or equal to 1 kHz, greater than or equal to 10 kHz, greater than or equal to 50 kHz, greater than or equal to 100 kHz, or even greater than or equal to 200 kHz. The average repetition rate f₀ of the light pulses B0, B1, B2 may be e.g. in the range of 1 kHz to 500 KHz.

Referring to FIG. 2b, the broadband light source LS1 may be arranged to operate such that the spectral bandwidth of the broadband light pulses B1 covers the intended spectral operating range MSR1 of the Fabry-Perot interferometer FPI1. The broadband light pulses B1 may have a spectral intensity distribution I_{B1}(λ).

Referring to FIGS. 2c and 2d, the spectral width Δλ_{FWHM} of the spectral transmittance peak PEAK1 of the Fabry-Perot interferometer FPI1 may be e.g. smaller than 20% of the spectral operating range MSR1 of the Fabry-Perot interferometer FPI1, advantageously smaller than 10%, and preferably smaller than 5%. The symbol Δλ_{FWHM} denotes the full spectral width at half maximum. The spectral width Δλ_{FWHM} of the formed narrowband light pulse B2 may be substantially equal to the spectral width Δλ_{FWHM} of the spectral transmittance peak PEAK1. A narrowband light pulse B2 may have a spectral intensity distribution I_{B2}(λ).

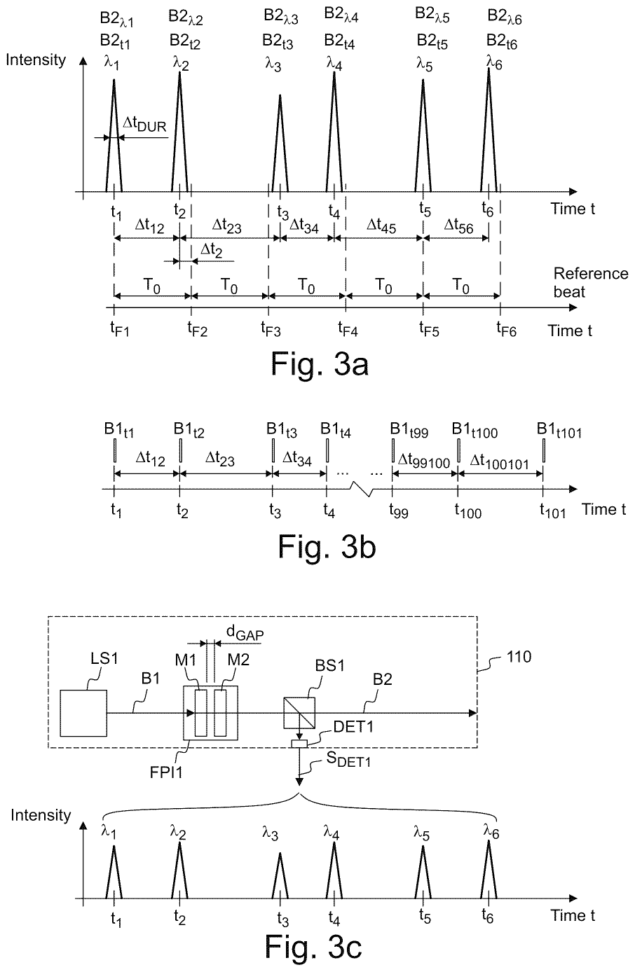

Referring to FIG. 3a, the broadband light source LS1 may be arranged to generate broadband light pulses B1 at an average repetition rate f₀. The average repetition rate f₀ may also be called e.g. as the base frequency. For the present purpose, each broadband light pulse B1 and the corresponding narrowband light pulse B2 may be considered to be formed at the same time, e.g. at the trigger time t₁. A first narrowband light pulse B2ₜ₁ may be formed at a first trigger time t₁, and may have a first wavelength λ₁. A second narrowband light pulse B2ₜ₂ may be formed at a second trigger time t₂, and may have a second wavelength λ₂. Pulses B2ₜ₁, B2ₜ₂, B2ₜ₃, B2ₜ₄, B2ₜ₅, B2ₜ₆, . . . may be formed at times t₁, t₂, t₃, t₄, t₅, t₆, . . . and at wavelengths λ₁, λ₂, λ₃, λ₄, λ₅, λ₆, . . . respectively. Time intervals Δt₁₂, Δt₂₃, Δt₃₄, Δt₄₅, Δt₅₆ between consecutive light pulses may have different lengths. Δt₁₂ denotes a time interval between the first light pulse and the second light pulse. Δt₂₃ denotes a time interval between the second light pulse and the second light pulse. The narrowband light pulses at the wavelengths λ₁, λ₂, λ₃, λ₄, λ₅, λ₆, . . . may also be marked with the symbols B2_{λ1}, B2_{λ2}, B2_{λ3}, B2_{λ4}, B2_{λ5}, B2_{λ6}, . . .

The average time period T₀ of the broadband light source is equal to 1/f₀. The symbols t_{F1}, t_{F2}, t_{F3} denote basic beat times of the broadband light source LS1. The time period between consecutive basic beat times t_{F1}, t_{F2}, t_{F3} is equal to the average time period T₀ between the light pulses B1 or B2. The time period T₀ between consecutive basic beat times t_{F1}, t_{F2}, t_{F3} is constant, whereas the time intervals between consecutive trigger times t₁, t₂, t₃ may vary from pulse to pulse. The time intervals between consecutive trigger times t₁, t₂, t₃ may vary e.g. depending on the desired wavelengths λ₁, λ₂, λ₃. For example, Δt₂ denotes a delay between the second trigger time t₂ and the corresponding basic beat time t_{F2}. Δt₃ denotes a delay between times t₃ and t_{F3}. Δt₄ denotes a delay between times t₄ and t_{F4}.

The apparatus 500 may comprise a clock CLK1 for determining the basic beat times t_{F1}, t_{F2}, t_{F3}. The control unit CNT1 may be arranged to form the modulating waveform S_{GAP}(t) such that the modulating waveform S_{GAP}(t) is synchronized with the basic beat times t_{F1}, t_{F2}, t_{F3}.

The amplification coefficient of the optical amplifier may depend on the actual time interval between consecutive light pulses. The actual time interval between consecutive light pulses may deviate from the average time period To according to the timing of the light pulses B1. The optical amplifier may allow a deviation, which is e.g. smaller than or equal to ±10% of the average time period T₀. Variation of the energy of the light pulses may be within an acceptable range e.g. in a situation where the time interval between consecutive light pulses is e.g. in the range of 80% to 120% of the average time period T₀.

The broadband light source LS1 may be arranged to emit broadband light pulses B1 repetitively such that the time interval (e.g. Δt₁₂) between each broadband light pulse B1 and the next broadband light pulse B1 is individually adjustable at least in the range of 90% to 110% of the average time period T₀ between the broadband light pulses B1.

The broadening of the effective spectral width Δλ_{FWHM, EFF} of a single narrowband light pulse B2 may be proportional to the duration Δt_{DUR} multiplied by the spectral scanning speed (Δλ/Δt) of the Fabry-Perot interferometer FPI1. The ratio (Δt_{DUR}/T₀) of the duration Δt_{DUR} of the pulse B1 (and B2) to the average time period T₀ may be e.g. smaller than 2%, smaller than 1%, smaller than 0.5%, or even smaller than 0.2%, so as to reduce spectral broadening of the narrowband light pulses B2.

The mirror gap d_{GAP} may be varied periodically between a minimum value d_{GAP, MIN} and a maximum value d_{GAP, MAX}, at a modulation frequency f_{SCAN}. The wavelength of the spectral transmittance peak may be varied between a minimum value λ_{MIN} and a maximum value λ_{MAX}, respectively. In case of sinusoidal modulation, the maximum spectral tuning speed (Δλ/Δt) may be e.g. substantially equal to 2π. f_{SCAN}·(λ_{MAX}−λ_{MIN}). The spectral difference (λ_{MAX}−λ_{MIN}) may be e.g. equal to 500 nm, the sinusoidal modulation frequency f_{SCAN} may be e.g. 200 kHz, and the corresponding maximum spectral tuning speed (Δλ/λt) is 2π·200 kHz·500 nm=6.3·10⁸ nm/s. The spectral shift of the transmittance peak PEAK1 during a single pulse may be equal to the duration Δt_{DUR} multiplied by the spectral tuning speed (Δλ/Δt). The duration Δt_{DUR} of the pulses may be e.g. shorter than 3 ns. For example, the spectral shift of the transmittance peak PEAK1 may be approximately equal to 1.9 nm during the time period Δt_{DUR}=3 ns at the sinusoidal modulation frequency f_{SCAN}=200 KHz, in the situation where (λ_{MAX}−λ_{MIN})=500 nm. The spectral shift of 1.9 nm is less than 0.4% of the difference (λ_{MAX}−λ_{MIN}). Referring to FIG. 3b, consecutive broadband light pulses B1ₜ₁, B1ₜ₂, B1ₜ₃, . . . B1ₜ₉₉, B1ₜ₁₀₀, B1ₜ₁₀₁ are triggered at trigger times t₁, t₂, t₃, . . . t₉₉, t₁₀₀, t₁₀₁. Corresponding narrowband light pulses B2 are also formed at the times t₁, t₂, t₃, . . . t₉₉, t₁₀₀, t₁₀₁. Each trigger time t₁, t₂, t₃, . . . t₉₉, t₁₀₀ defines a time interval Δt₁₂, Δt₂₃, Δt₃₄, . . . Δt₉₉₁₀₀, Δt₁₀₀₁₀₁ together with the next trigger time t₂, t₃, t₄, . . . t₁₀₀, t₁₀₁.

The consecutive trigger times t₁, t₂, t₃, . . . t₁₀₁ define 100 consecutive time intervals Δt₁₂, Δt₂₃, Δt₃₄, . . . Δt₉₉₁₀₀, Δt₁₀₀₁₀₁ between the 101 consecutive light pulses B1ₜ₁, B1ₜ₂, B1ₜ₃, . . . B1ₜ₉₉, B1ₜ₁₀₀, B1ₜ₁₀₁.

The apparatus 500 may be arranged to operate such that each of the 100 consecutive time intervals Δt₁₂, Δt₂₃, Δt₃₄, . . . Δt₉₉₁₀₀, Δt₁₀₀₁₀₁ is e.g. in the range of 80% to 120% of the average time period T₀.

The average time period T₀ is the average of the time intervals between consecutive broadband light pulses B1. In particular, the average time period T₀ may be defined to be equal to the average of 100 consecutive time intervals Δt₁₂, Δt₂₃, Δt₃₄, . . . Δt₉₉₁₀₀, Δt₁₀₀₁₀₁ between the broadband light pulses B1.

Referring to FIG. 3c, the illuminating unit 110 may optionally comprise a beam splitter BS1, and a reference detector DET1, wherein a part of the light of the light pulses B1 or B2 may be directed to the reference detector DET1 via the beam splitter BS1 so as to measure the energy and/or intensity of the light pulses B1 or B2. The reference detector DET1 may form a detector signal S_{DET1}, which is indicative of the energy and/or intensity of the light pulses B1 or B2. The control unit CNT1 may be arranged to use the measured the energy and/or intensity of the light pulses B1 or B2 for compensating an effect of the variation of the energy and/or intensity on the pixel values of the captured spectral images IMG1_{λ1}, IMG1_{λ2}, IMG1_{λ3}.

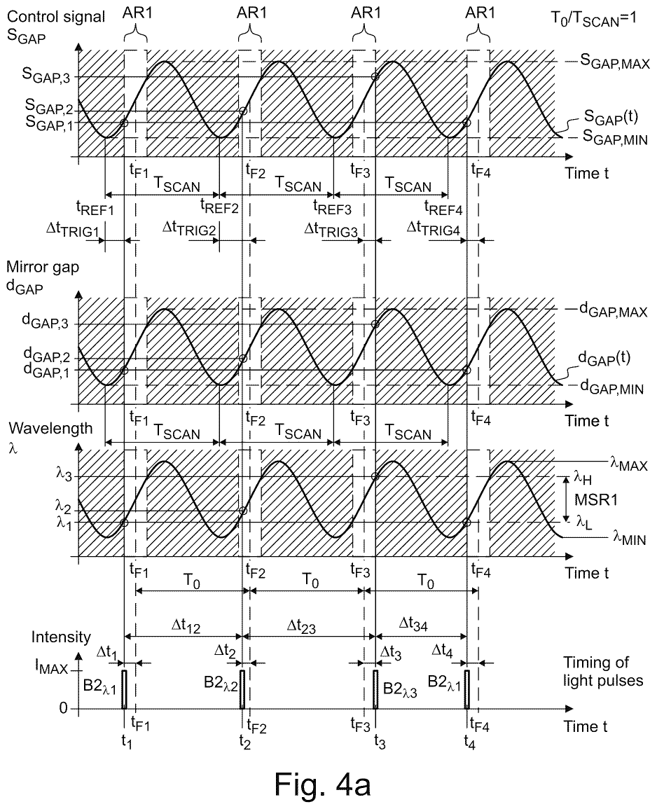

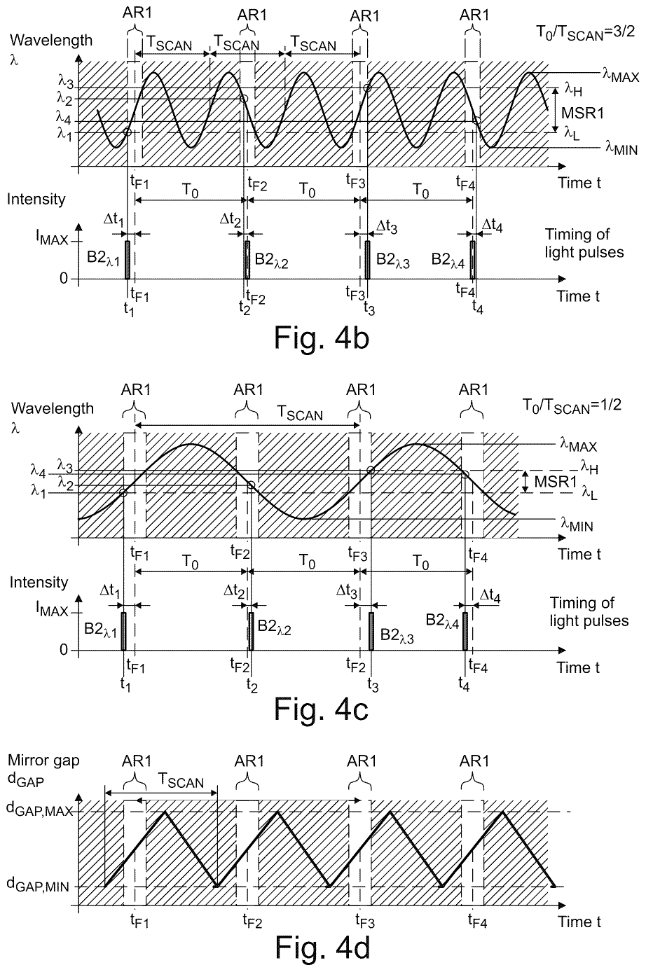

FIG. 4a shows, by way of example, the modulating control signal S_{GAP}(t), the temporal evolution of the corresponding mirror gap d_{GAP}(t), the temporal evolution of the corresponding wavelength λ(t) of the spectral transmittance peak PEAK1, and the timing of the broadband light pulses B1. The control unit CNT1 determines trigger times t₁, t₂, t₃, and also triggers the broadband light pulses B1 at the times t₁, t₂, t₃, for producing narrowband light pulses B2 at the desired wavelengths λ₁, λ₂, λ₃.

The modulating waveform S_{GAP}(t) has a modulation time period T_{SCAN}. The inverse (1/T_{SCAN}) of the modulation time period T_{SCAN} is equal to the modulation frequency f_{SCAN}. The modulating control signal S_{GAP}(t) varies periodically between a minimum value S_{GAP, MIN} and a maximum value S_{GAP, MAX}. The modulating signal S_{GAP}(t) has a period T_{SCAN}. The modulating signal S_{GAP}(t) may be e.g. a sinusoidal signal at a constant frequency f_{SCAN}=1/T_{SCAN}. The modulating signal S_{GAP}(t) may be synchronized with basic beat times t_{F1}, t_{F2}, t_{F3}, t_{F4}. A first value S_{GAP, 1} of the modulating signal may be associated with a first mirror gap d_{GAP, 1} and with a first wavelength λ₁. A second value S_{GAP, 2} of the modulating signal may be associated with a second mirror gap d_{GAP, 2} and with a second wavelength λ₂. A third value S_{GAP, 3} of the modulating signal may be associated with a third mirror gap d_{GAP, 3} and with a third wavelength λ₃.

The mirror gap d_{GAP} varies between a minimum value d_{GAP, MIN} and a maximum value d_{GAP, MAX} according to the periodic modulating waveform. The wavelength λ of the spectral transmittance peak varies between a minimum wavelength λ_{MIN} and a maximum wavelength λ_{MAX} according to the periodic modulating waveform.

The mirror gap d_{GAP} and the wavelength of the transmittance peak are modulated at the frequency f_{SCAN}=1/T_{SCAN}.

The wavelength λ of the spectral transmittance peak PEAK1 is varied between a minimum value λ_{MIN}, and a maximum value λ_{MAX}. The spectral measurement range MSR1 has a lower limit λ_{L} and a higher limit λ_{H}. The lower limit λ_{L} is higher than or equal to the minimum value λ_{MIN}. The higher limit λ_{H} is lower than or equal to the maximum value λ_{MAX}.

The control unit CNT1 may be arranged trigger emission of a broadband light pulse B1 when the mirror gap d_{GAP} is momentarily equal to a first value d_{GAP, 1}, which corresponds to the first wavelength λ₁.

The average time period T₀ between consecutive light pulses B1 is equal to the inverse (1/f₀) of the average repetition rate f₀ of the light pulses B1. The average time period T₀ may also be called as the base time period T₀. The average repetition rate f₀ may also be called as the base frequency f₀.

AR1 denotes an allowed temporal range for a trigger time, for example a range where the trigger time deviates at most 0.1·T₀ from the nearest basic beat time (e.g. from the time t_{F1} or t_{F2}). I_{MAX} may denote the maximum intensity of light pulses B1 or B2.

The modulation frequency f_{SCAN} may be e.g. equal to the base frequency f₀. The illuminating unit 110 may be arranged to operate such that f_{SCAN}=f₀. The illuminating unit 110 may be arranged to operate such that T₀=T_{SCAN}. In this case, the wavelength of each narrowband light pulse may be individually selected from the same spectral operating range MSR1, from a lower limit λ_{L} to an upper limit λ_{H}.

The illuminating unit 110 may be arranged to form a narrowband light pulse B2 at a first wavelength λ₁ by controlling the timing of a broadband light pulse B1 with respect to the modulating waveform S_{GAP}(t). The control unit CNT1 may be arranged to trigger emission of the broadband light pulse B1 at the time t₁ when the mirror gap d_{GAP} is momentarily equal to the mirror gap value d_{GAP, 1}, which corresponds to the first wavelength λ₁.

The apparatus 500 may comprise a clock CLK1 for determining basic beat times t_{F1}, t_{F2}, t_{F3}, t_{F4} at the constant intervals T₀. Consecutive basic beat times t_{F1}, t_{F2}, t_{F3}, t_{F4} are separated from each other by the constant time period T₀. The control unit CNT1 may be arranged to form the modulating waveform S_{GAP}(t) such that the modulating waveform S_{GAP}(t) is synchronized with the basic beat times t_{F1}, t_{F2}, t_{F3}, t_{F4}.

The control unit CNT1 may be arranged to trigger a first broadband light pulse B1 according to a first time delay Δt₁ between the first broadband light pulse B1 and the nearest basic beat time (t_{F1}), so as to form the first narrowband light pulse B2 at a first selectable wavelength λ₁.

The control unit CNT1 may be arranged to trigger a second broadband light pulse B1 according to a second time delay Δt₂ between the second broadband light pulse B1 and the nearest basic beat time (t_{F2}), so as to form the second narrowband light pulse B2 at a second selectable wavelength λ₂.

The control unit CNT1 may be arranged to trigger a third broadband light pulse B1 according to a third time delay Δt₃ between the third broadband light pulse B1 and the nearest basic beat time (t_{F3}), so as to form the third narrowband light pulse B2 at a third selectable wavelength λ₃.

The control unit CNT1 may be arranged to trigger a fourth broadband light pulse B1 according to a fourth time delay Δt₄ between the fourth broadband light pulse B1 and the nearest basic beat time (t_{F4}), so as to form the fourth narrowband light pulse B2 at a fourth selectable wavelength λ₄.

The control unit CNT1 may be arranged to:
modulate the mirror gap d_{GAP} of the Fabry-Perot interferometer FPI1 between a minimum value d_{GAP, MIN} and a maximum value d_{GAP, MAX} according to a periodic modulating waveform S_{GAP}(t),
trigger a first broadband light pulse B1 at a first trigger time t₁, so as to form a first narrowband light pulse B2 at a first wavelength λ₁,
trigger a second broadband light pulse B1 at a second trigger time t₂, so as to form a second narrowband light pulse B2 at a second wavelength λ₂,
   wherein the first trigger time t₁ may be associated with a first value S_{GAP, 1} of the modulating waveform S_{GAP}(t),
   wherein the second trigger time t₂ may be associated with a second different value S_{GAP, 2} of the modulating waveform S_{GAP}(t),
   wherein the time interval Δt₁₂ between the first trigger time t₁ and the second trigger time t₂ may be e.g. in the range of 80% to 120% of the average time period T₀ between consecutive the broadband light pulses B1.

The time interval Δt₁₂ between the trigger time t₁ of a first light pulse B1 and the trigger time t₂ of a second light pulse B1 may be in the range of 80% to 120% of the average time period T₀.

The time interval Δt₂₃ between the trigger time t₂ of a second light pulse B1 and the trigger time t₃ of a third light pulse B1 may be in the range of 80% to 120% of the average time period T₀.

The time interval Δt₃₄ between the trigger time t₃ of a third light pulse B1 and the trigger time t₄ of a fourth light pulse B1 may be in the range of 80% to 120% of the average time period T₀.

The control unit CNT1 may be arranged to trigger the broadband light pulses B1 such that the time interval between the trigger time (e.g. t₁, or t₂) of each light pulse B1 and the nearest basic beat time (e.g. t_{F1} or t_{F2}) is e.g. less than or equal to 10% of the average time period T₀ between consecutive the broadband light pulses B1.

The control unit CNT1 may be arranged to trigger e.g. at least 100 consecutive broadband light pulses B1 such that the time interval between the trigger time (e.g. t₁, or t₂) of each light pulse B1 and the nearest basic beat time (e.g. t_{F1} or t_{F2}) is e.g. less than or equal to 10% of the average time period T₀ between the consecutive broadband light pulses B1. The trigger times t₁, t₂, t₃, t₄ of the broadband light pulses B1 may be selected e.g. such that the number of the different wavelengths λ₁, λ₂, λ₃, λ₄, . . . of the narrowband light pulses B2 may be e.g. at least 2, 3, 4, 5, 6, 7, 8, 9, or 10.

The Fabry-Perot interferometer may have one or more resonance frequencies due to masses of the parts of the interferometer, and due to elastic properties of the parts. Furthermore, ambient gas (if present) may also contribute to one or more resonance frequencies. It may be advantageous to use the apparatus such that the modulation frequency f_{SCAN} is close to a mechanical resonance frequency of the Fabry-Perot interferometer, so as to reduce the power needed for modulating the mirror gap.

Varying the mirror gap of the Fabry-Perot interferometer at a constant modulation frequency may reduce a risk of damaging the mirrors, in a situation where the modulation frequency is close to a resonance frequency. The resonance frequencies may depend on the masses of the parts and on the spring constants of the parts. For example, a larger Fabry-Perot interferometer may have resonances at lower frequencies. For example, a smaller Fabry-Perot interferometer may have resonances at higher frequencies.

The mirror gap d_{GAP} of the Fabry-Perot interferometer FPI1 may be modulated at a constant modulating frequency f_{SCAN}. The mirror gap may be modulated e.g. according to a sinusoidal waveform S_{GAP}(t). The mirror gap d_{GAP}(t) of the Fabry-Perot interferometer FPI1 may be a sinusoidal function of time. The constant modulating frequency f_{SCAN} may e.g. reduce a risk of damaging the Fabry-Perot interferometer FPI1 in a situation where the control sequence SEQ1 is modified. The modulation frequency f_{SCAN} may be e.g. equal to the base frequency f₀. The illuminating unit 110 may be arranged to operate such that f_{SCAN}=f₀. The illuminating unit 110 may be arranged to operate such that T₀=T_{SCAN}.

The modulation frequency f_{SCAN} may be e.g. greater than or equal to the base frequency f₀. The illuminating unit 110 may be arranged to operate such that f_{SCAN}≥f₀. The illuminating unit 110 may be arranged to operate such that T₀≥T_{SCAN}. The modulation frequency f_{SCAN} of the mirror gap may be greater than or equal to two times the base frequency f₀ of the broadband light source, so as to allow reducing the relative deviation of the time interval between consecutive light pulses, and so as to allow more freedom to select the wavelengths of the narrowband light pulses.

In case of sinusoidal modulation at the constant frequency f₀, the condition f_{SCAN}=2. f₀ may allow selecting the wavelength of each narrowband light pulse B2 from the same spectral operating range MSR1 (from the lower limit λ_{L} to the higher limit λ_{H}), which may be almost as broad as the full spectral range of the Fabry-Perot interferometer (from the minimum wavelength λ_{MIN} to the maximum wavelength λ_{MAX}). The condition f_{SCAN}=2·f₀ may also represent an optimum situation regarding the scanning speed of the Fabry-Perot interferometer FPI1 and the repetition rate of the light pulses, while providing the wide range of possible wavelengths λ₁, λ₂, λ₃, . . . The condition f_{SCAN}=2·f₀ may maximize the pulse repetition rate for a given modulation frequency of the Fabry-Perot interferometer FPI1, while providing the wide range of possible wavelengths λ₁, λ₂, λ₃, . . .

The modulating waveform S_{GAP}(t) has reference points, which may represent the beginning of each period of the modulating waveform S_{GAP}(t). For example, the minimum points S_{GAP, MIN} at the times t_{REF1}, t_{REF2}, t_{REF3} may be reference points of the modulating sinusoidal waveform S_{GAP}(t). The symbols t_{REF1}, t_{REF2}, t_{REF3}, t_{REF4} may denote the beginning of a first, second, third, and fourth period of the modulating waveform, respectively. The time period T_{SCAN} between consecutive reference points at the times t_{REF1}, t_{REF2}, t_{REF3} is equal to the inverse of the modulation frequency f_{SCAN}. Δt_{TRIG1} denotes a delay between a first reference time t_{REF1} and the trigger time t₁ of a first light pulse B1 (or B2). Δt_{TRIG2} denotes a delay between a second reference time t_{REF2} and the trigger time t₂ of a second light pulse. Δt_{TRIG3} denotes a delay between a third reference time t_{REF3} and the trigger time t₃ of a third light pulse. Δt_{TRIG4} denotes a delay between a fourth reference time t_{REF4} and the trigger time t₄ of a fourth light pulse. The control unit CNT1 may be arranged to determine the delays Δt_{TRIG1}, Δt_{TRIG2}, Δt_{TRIG3}, Δt_{TRIG4} according to the control sequence SEQ1, so as to form the narrowband light pulses B2 at the desired wavelengths λ₁, λ₂, λ₃. (In this example, the wavelength of the fourth pulse may also be equal to λ1). The control unit CNT1 may be arranged to trigger the broadband light pulses B1 according to the determined delays Δt_{TRIG1}, Δt_{TRIG2}, Δt_{TRIG3}, Δt_{TRIG4}.

Referring to FIG. 4b, the constant modulation frequency f_{SCAN} may be e.g. equal to a positive integer number M times the half of the base frequency f₀. The illuminating unit 110 may be arranged to operate such that f_{SCAN}=M·f₀/2. The illuminating unit 110 may be arranged to operate such that T₀=M·T_{SCAN}/2. Consequently, the wavelength of each narrowband light pulse may be individually selected from the same spectral range.

Referring to FIG. 4c, the average repetition rate (f₀) of the broadband light pulses (B1) may e.g. be smaller than or equal to two times the frequency (f_{SCAN}) of the modulating waveform (S_{GAP}).

The modulation frequency f_{SCAN} may be e.g. greater than or equal to half of the base frequency f₀. The illuminating unit 110 may be arranged to operate such that f_{SCAN}>f₀/2. The illuminating unit 110 may be arranged to operate such that T₀>T_{SCAN}/2.

The apparatus 500 may be arranged to generate at most one broadband light pulse B1 during each half period T_{SCAN}/2 of the modulating waveform S_{GAP}(t) of the Fabry-Perot interferometer FPI1.

The constant modulation frequency f_{SCAN} may be e.g. equal to half of the base frequency f₀. The illuminating unit 110 may be arranged to operate such that f_{SCAN}=f₀/2. The illuminating unit 110 may be arranged to operate such that T₀=T_{SCAN}/2. Consequently, the wavelength of each narrowband light pulse may be individually selected from the same spectral range MSR1.

The apparatus 500 may be arranged to generate only one broadband light pulse B1 during each a half period T_{SCAN}/2 of the modulating waveform S_{GAP}(t). The apparatus 500 may be arranged to generate a single broadband light pulse B1 during a half period T_{SCAN}/2 of the modulating waveform S_{GAP}(t).

Referring to FIG. 4d, the mirror gap d_{GAP} may also be modulated e.g. according to a triangular waveform. The mirror gap d_{GAP}(t) may be a triangular function of time. The modulating waveform S_{GAP}(t) may be triangular. The waveform of the control signal S_{GAP}(t) may be a triangular function of time. The triangular waveform may e.g. provide substantially constant rate of change of the wavelength at each position of the spectral operating range MSR1.

On the other hand, the sinusoidal waveform may allow a higher modulation frequency f₀, when compared with the triangular waveform.

The Fabry-Perot interferometer may be arranged to operate in a gas GAS1, which is at the normal atmospheric pressure (approximately 101.3 kPa), or at a reduced pressure.

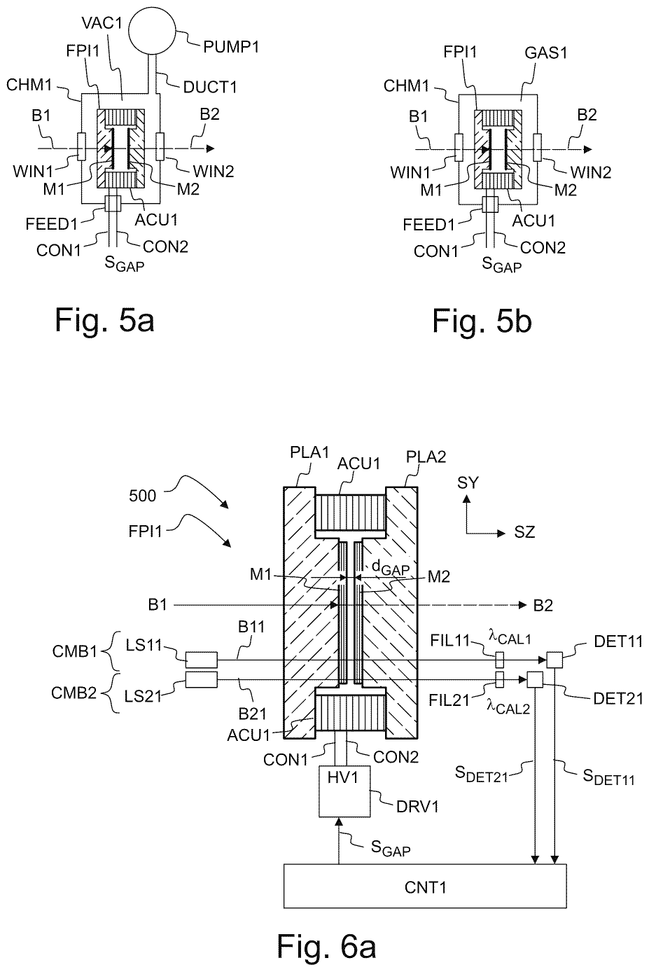

Referring to FIGS. 5a and 5b, the Fabry-Perot interferometer may be arranged to operate in a vacuum VAC1 so as to facilitate movements of the mirror M2. The presence of ambient air at the normal pressure of 101.3 kPa may disturb or slow down the movement of the mirror M2. The vacuum VAC1 means herein a low-pressure gas GAS1, where the absolute pressure is e.g. lower than 10 kPa (i.e. less than 0.1 bar). The Fabry-Perot interferometer FPI1 may be arranged to operate at the reduced pressure (VAC1), so as to reduce or avoid an effect of ambient gas on the movement of the mirror M2. Operation at the reduced pressure may e.g. allow using a high modulation frequency of the Fabry-Perot interferometer FPI1. The Fabry-Perot interferometer FPI1 may be arranged to operate in a vacuum VAC1. The absolute pressure in the vacuum VAC1 may be e.g. lower than 10 kPa, or even lower than 1 kPa. The Fabry-Perot interferometer may be positioned in a vacuum chamber CHM1. The vacuum chamber CHM1 may optionally have optical feedthroughs WIN1, WIN2 for transmitting light pulses B1, B2 to the Fabry-Perot interferometer and/or from the Fabry-Perot interferometer. The vacuum chamber CHM1 may optionally have electrical feedthroughs FEED1 for coupling a control voltage S_{FPI1} to the actuators ACU1 of the Fabry-Perot interferometer. The control signal S_{FPI1} may be applied to the one or more actuators ACU1 e.g. via conductors CON1, CON2.

The vacuum chamber CHM1 may be optionally connected to a vacuum pump PUMP1, optionally by using a duct DUCT1, so as to provide the vacuum VAC1 during operation of the Fabry-Perot interferometer FPI1. The vacuum chamber CHM1 may contain gas GAS1. The gas GAS1 may be pumped away from the vacuum chamber CHM1 by using the pump PUMP1. The internal pressure of the vacuum chamber CHM1 may be reduced by using the vacuum pump, e.g. so that the absolute pressure is lower than 10 kPa, advantageously lower than 1 kPa during operation of the apparatus 500.

Referring to FIG. 5b, the vacuum chamber CHM1 may also have a permanent vacuum VAC1. The Fabry-Perot interferometer (FPI1) may be positioned in a hermetically sealed vacuum chamber (CHM1), wherein the absolute pressure inside the vacuum chamber (CHM1) is smaller than 10 kPa, or even smaller than 1 kPa.

In an embodiment, the Fabry-Perot interferometer FPI1 may also be arranged to operate in a gas GAS1, which has low molar mass, so as to facilitate operation at a high modulation frequency f_{SCAN}. The gas GAS1 may be e.g. helium (He) or hydrogen (H₂). The GAS1 may be e.g. at the normal pressure (101.3 kPa) or at a reduced pressure, e.g. below 10 kPa.

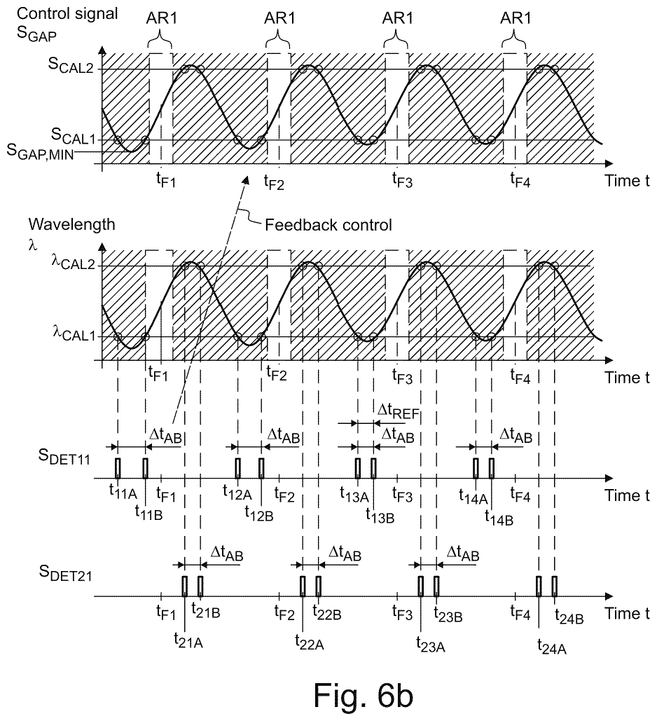

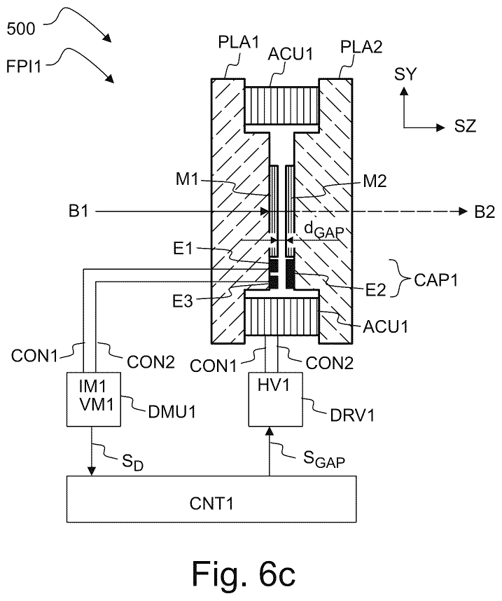

Referring to FIG. 6a, the apparatus 500 may comprise calibration light sources LS11, LS21 and calibration detectors DET11, DET21 for calibrating the spectral scale of the Fabry-Perot interferometer FPI1. For example, the control unit CNT1 may be arranged to adjust the minimum and maximum values of the modulating waveform based on signals S_{DET11}, S_{DET21} obtained from the calibration detectors DET11, DET21

A first control signal value S_{CAL1} may be associated with a first spectral position λ_{CAL1} by using a first calibration detector DET11. A first calibration light source LS11 may be e.g. a laser, which emits narrowband light B11 at a first calibration wavelength λ_{CAL1}. The calibration detector DET11 may detect light transmitted through the Fabry-Perot interferometer FPI1 only when the wavelength λ of the transmittance peak PEAK1 matches the first calibration wavelength λ_{CAL1}. A second control signal value S_{CAL2} may be associated with a second spectral position λ_{CAL2} by using a second calibration detector DET21. A second calibration light source LS21 may be e.g. a laser, which emits narrowband light B21 at a second calibration wavelength λ_{CAL2}. The calibration detector DET21 may detect light transmitted through the Fabry-Perot interferometer FPI1 only when the wavelength λ of the transmittance peak PEAK1 matches the second calibration wavelength λ_{CAL2}.

The apparatus 500 may optionally comprise one or more optical filters FIL11, FIL21 to define the bandwidth of the calibration light B11, B21.

The apparatus 500 may comprise a first spectrally selective combination CMB1 of a calibration light source LS11, and a calibration detector DET11. The calibration light source LS11 may be arranged to provide first calibration light B11. The calibration detector DET11 may be arranged to detect first calibration light B11 that has passed through the Fabry-Perot interferometer FPI1. The first spectrally selective combination CMB1 may be arranged to form a calibration detector signal S_{DET11}. The first spectrally selective combination CMB1 may be arranged to change a state of the calibration detector signal S_{DET11} when the wavelength λ of the spectral transmittance peak PEAK1 of the Fabry-Perot interferometer FPI1 becomes higher or lower than the first predetermined calibration wavelength λ_{CAL1}.

The calibration detector signal S_{DET11} may change state e.g. from a low (lower) value to a high (higher) value, or from a high value to a low value. For example, the combination CMB1 may provide a high calibration detector signal value S_{DET11} when the wavelength λ of the spectral transmittance peak PEAK1 is equal to the first calibration wavelength λ_{CAL1}, wherein the combination CMB1 may provide a low calibration detector signal value S_{DET11} when the wavelength λ of the spectral transmittance peak PEAK1 is higher or lower than the first calibration wavelength λ_{CAL1}.

The light source LS11 may be e.g. a laser, which emits light at the first calibration wavelength λ_{CAL1}. The optical filter FIL11 is optional when the light source LS11 is a laser. The combination CMB1 may optionally comprise the filter FIL11. The light source LS11 may also be a broadband light source, e.g. a light emitting diode, wherein the spectral selectivity may be provided by using the optical filter FIL11. The filter FIL11 may be positioned between the light source LS11 and the Fabry-Perot interferometer FPI1, or the filter FIL11 may be positioned between the Fabry-Perot interferometer FPI1 and the detector DET11. The filter FIL11 may have a narrow passband, to provide a calibration detector signal pulse S_{DET11} when the spectral transmittance peak PEAK1 is momentarily at the first calibration wavelength λ_{CAL1}. The filter FIL11 may also be a long pass filter or a short pass filter. The calibration detector signal S_{DET11} may change state from a low value to a high value, or from a high value to a low value, when the wavelength of the spectral transmittance peak PEAK1 becomes higher or lower than the first calibration wavelength λ_{CAL1}. The spectrally selective combination CMB1 may be arranged to operate such that the calibration signal S_{DET11} changes state when the wavelength λ of the spectral transmittance peak PEAK1 becomes higher or lower than the first calibration wavelength λ_{CAL1}.

The apparatus 500 may comprise a second spectrally selective combination CMB2 of a calibration light source LS21, and a calibration detector DET21. The calibration light source LS21 may be arranged to provide second calibration light B21. The calibration detector DET21 may be arranged to detect second calibration light B21 that has passed through the Fabry-Perot interferometer FPI1. The second spectrally selective combination CMB2 may be arranged to form a calibration detector signal S_{DET21}. The second spectrally selective combination CMB2 may be arranged to change a state of the calibration detector signal S_{DET21} when the wavelength λ of the spectral transmittance peak PEAK1 of the Fabry-Perot interferometer FPI1 becomes higher or lower than the second predetermined calibration wavelength λ_{CAL2}.

For example, the combination CMB2 may provide a high calibration detector signal value S_{DET21} when the wavelength λ of the spectral transmittance peak PEAK1 is equal to the second calibration wavelength λ_{CAL2}, wherein the combination CMB2 may provide a low calibration detector signal value S_{DET21} when the wavelength λ of the spectral transmittance peak PEAK1 is higher or lower than the second calibration wavelength λ_{CAL2}.

In an embodiment, the first combination CMB1 and the second combination CMB2 may also share a common light source (e.g. LS11) or a common detector (e.g. DET11).

In an embodiment, also the broadband light source LS1 may be used as the calibration light source LS11. For example, light of the broadband light pulses B1 may be used as the calibration light B11 together with the optical filter FIL11 and with the detector DET11. For example, light of the broadband light pulses B1 may be used as the calibration light B21 together with the optical filter FIL21 and with the detector DET21.

Referring to FIG. 6b, the first calibration detector DET11 may provide a pulse when the wavelength λ of the transmittance peak PEAK1 matches the first calibration wavelength λ_{CAL1} (e.g. at times t_{11A}, t_{11B}). The control unit CNT1 may be arranged to adjust the minimum value S_{GAP, MIN} of the modulating signal S_{GAP} e.g. such that the time interval Δt_{AB} between consecutive pulses of the calibration detector signal S_{DET11} is equal to a predetermined value Δt_{REF}.

The second calibration detector DET21 may provide a pulse when the wavelength λ of the transmittance peak PEAK1 matches the second calibration wavelength λ_{CAL2} (e.g. at times t_{21A}, t_{21B}). The control unit CNT1 may be arranged to adjust the maximum value S_{GAP, MAX} of the modulating signal S_{GAP} e.g. such that the time interval Δt_{AB} between consecutive pulses is equal to a predetermined value Δt_{REF}.

The first calibration detector DET11 may provide pulses e.g. at times t_{11A}, t_{11B}, t_{12A}, t_{12B}, t_{13A}, t_{13B}, t_{14A}, t_{14B}. The second calibration detector DET21 may provide pulses e.g. at times t_{21A}, t_{21B}, t_{22A}, t_{22B}, t_{23A}, t_{23B}, t_{24A}, t_{24B}.

The apparatus 500 may be arranged to associate a first (auxiliary) value S_{CAL1} of the control signal S_{GAP} with the first calibration wavelength λ_{CAL1} by using the calibration signal S_{DET11}, which is obtained from the first spectrally selective combination CMB1 of a light source LS11 and a calibration detector DET11.

The apparatus 500 may be arranged to associate a second (auxiliary) value S_{CAL2} of the control signal S_{GAP} with the second calibration wavelength λ_{CAL2} by using the calibration signal S_{DET21}, which is obtained from the second spectrally selective combination CMB2 of a light source LS21 and a calibration detector DET21.

Referring to FIG. 6c, the Fabry-Perot interferometer FPI1 may optionally comprise one or more sensors CAP1 for measuring the mirror gap dGAP. The sensor CAP1 may be e.g. a capacitive sensor. The sensor may also be e.g. an optical sensor (see FIG. 6a). The capacitive sensor CAP1 may comprise e.g. electrodes E1, E2, E3. Electrodes E1, E2 may form a first sensor capacitor. Electrodes E2, E3 may form a second sensor capacitor. The electrodes E1, E3 may be stationary. The electrode E2 may be attached to the moving mirror plate PLA2. One or more sensor capacitors may also be connected in series. The capacitance of the capacitive sensor CAP1 may depend on the mirror gap d_{GAP}. The apparatus 500 may optionally comprise a distance measuring unit DMU1, which may be arranged to measure the mirror gap dGAP by measuring the capacitance of the sensor CAP1. The distance measuring unit DMU1 may measure the capacitance e.g. by coupling a voltage signal VM1 to the sensor CAP1 and by monitoring a corresponding current IM1 of the sensor CAP1 and/or the distance measuring unit DMU1 may measure the capacitance e.g. by coupling a current signal IM1 to the sensor CAP1 and by monitoring a corresponding voltage VM1 of the sensor CAP1. The distance measuring unit DMU1 may be connected to the electrodes E1, E3 via conductors CON1, CON2. The distance measuring unit DMU1 may form a signal S_{D}, which is indicative of the measured mirror gap d_{GAP}. The control unit CNT1 may use the signal S_{D} as feedback.

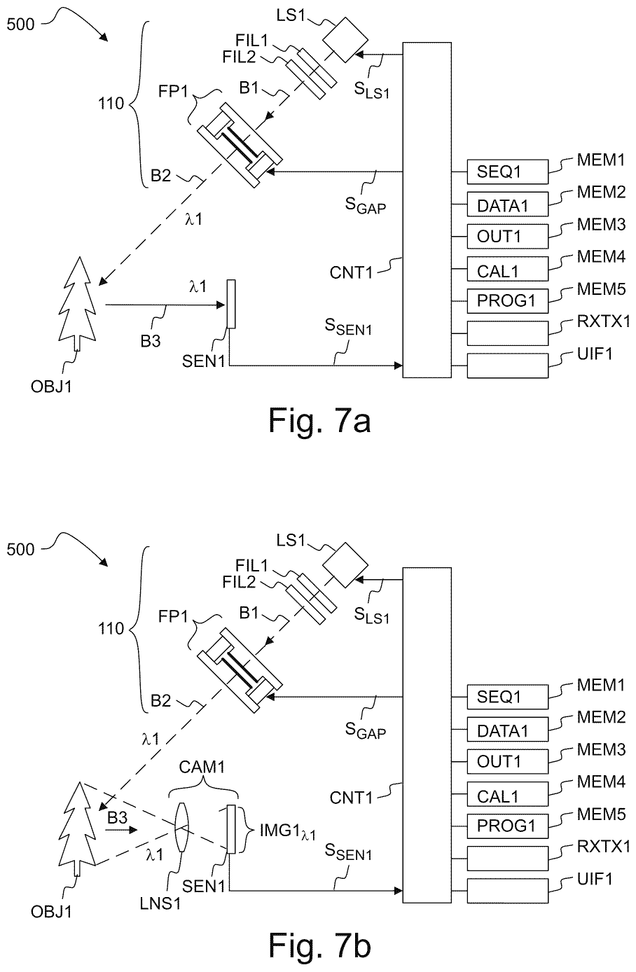

Referring to FIG. 7a, the apparatus 500 may be a non-imaging spectrometer. The illuminating unit 110 may illuminate an object OBJ1 with narrowband light pulses B2. A detector SEN1 may detect light B3, which is received from the object OBJ1 when the object OBJ1 is illuminated with a narrowband light pulse B2, e.g. at a first wavelength λ₁. The detector SEN1 may be a non-imaging detector. For example, the apparatus 500 may be arranged to measure one or more spectral properties of a single point of the object OBJ1.

Referring to FIG. 7b, the apparatus 500 may be a spectral imaging device. The apparatus 500 may be an imaging spectrometer. The illuminating unit 110 may illuminate an object OBJ1 with narrowband light pulses B2. An imaging unit CAM1 may capture spectral images IMG1 of the object OBJ1 when the object OBJ1 is illuminated with a narrowband light pulse B2, e.g. at a first wavelength λ₁. The imaging unit CAM1 may comprise focusing optics LNS1 to focus received light B1 to the image sensor SEN1. The detector pixels of the image sensor may be arranged e.g. in a two-dimensional array.

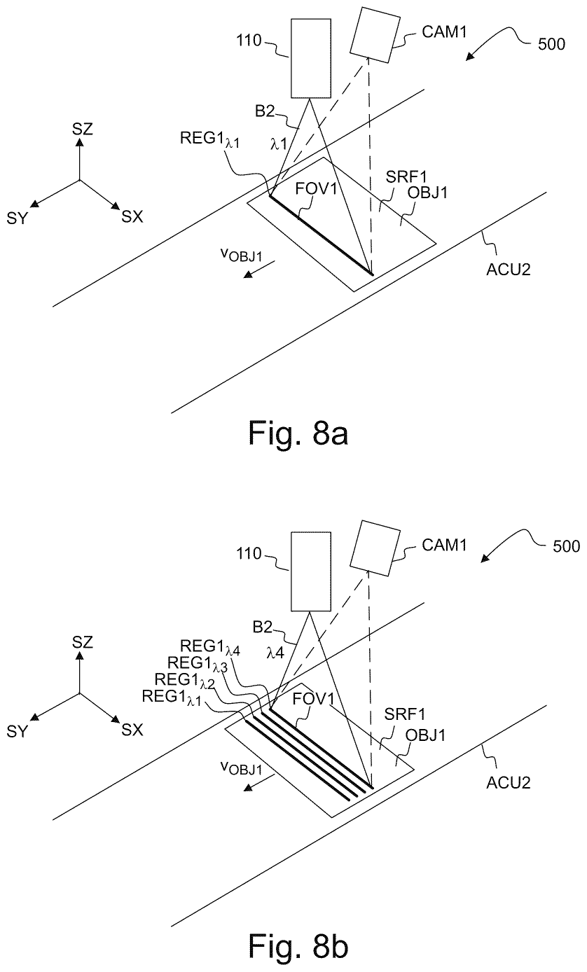

Referring to FIGS. 8a and 8b, the apparatus 500 may comprise a line scan camera CAM1, which comprises a one-dimensional image sensor SEN1. The image sensor SEN1 of the line scan camera CAM1 may comprise e.g. only one active row of detector pixels. The image sensor SEN1 may capture a one-dimensional spectral image IMG1, which comprises a 1×M array of image pixels. The one-dimensional image sensor SEN1 may be arranged to capture images at a high rate, e.g. higher than or equal to 10 kHz, or even higher than or equal to 100 kHz.

An object OBJ1 may be moved at a relative velocity V_{OBJ1} with respect to the field-of-view FOV1 of the camera CAM1. The moving object OBJ1 may be illuminated with the narrowband light pulses B2_{λ1}, B2_{λ2}, and the camera CAM1 may be arranged to capture spectral images IMG1_{λ1}, IMG_{λ2} of the illuminated object OBJ1 in a synchronized manner. The spectral images IMG1_{λ1}, IMG_{λ2} may be one-dimensional. Each spectral image IMG1_{λ1}, IMG_{λ2} may e.g. consist of 1×M image pixels, where the number M may be e.g. in the range of 100 to 20000. The illuminating unit 110 may sequentially illuminate a plurality of adjacent regions REG1_{λ1}, REG1_{λ2}, REG1_{λ3}, REG1_{λ4}, . . . of the object OBJ1. The line scan camera CAM1 may sequentially capture images IMG1_{λ1}, IMG1_{λ2}, IMG1_{λ3}, IMG1_{λ4}, . . . of the illuminated regions REG1_{λ1}, REG1_{λ2}, REG1_{λ3}, REG1_{λ4}, . . . at different times t₁, t₂, t₃, t₄, . . .

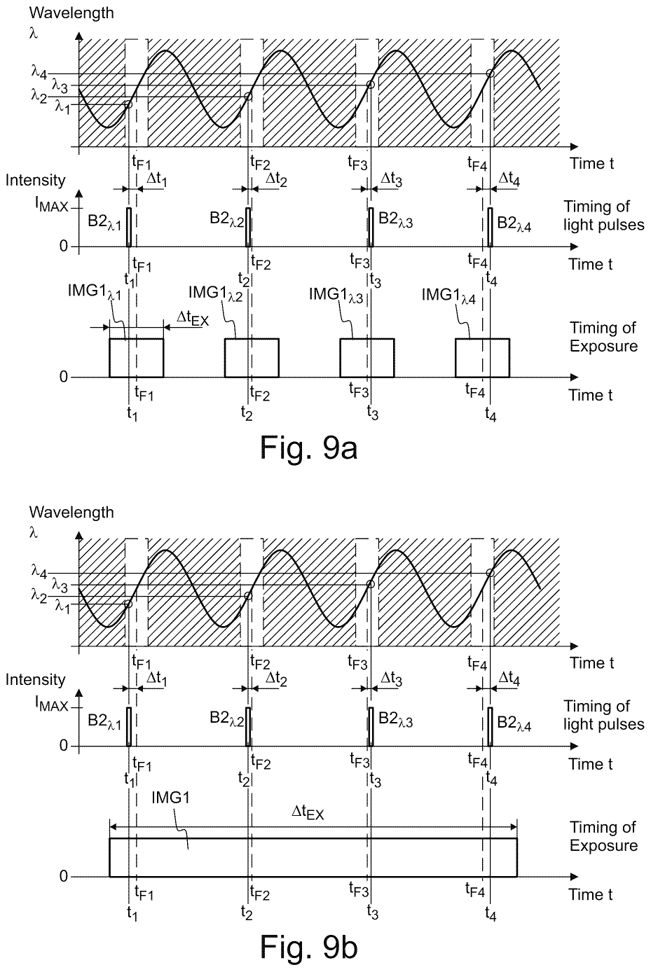

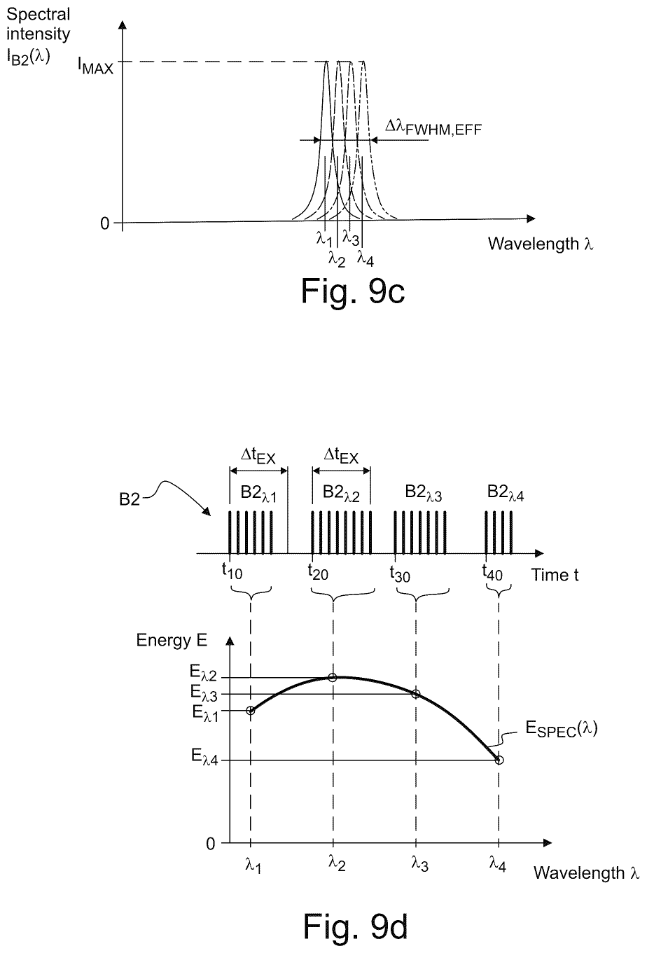

Referring to FIG. 9a, imaging unit CAM1 of the apparatus 500 may be arranged to capture spectral images IMG1_{λ1}, IMG1_{λ2}, IMG1_{λ3}, IMG1_{λ4} such that the illuminating unit 110 forms only one narrowband light pulse B2 during an exposure time Δt_{E} of the image sensor SEN1.

Referring to FIG. 9b, imaging unit CAM1 of the apparatus 500 may be arranged to capture an images IMG1, such that the illuminating unit 110 forms two or more narrowband light pulses B2 during an exposure time Δt_{EX} of the image sensor SEN1. The narrowband light pulses B2 may be at the same wavelength, e.g. in order to improve signal-to-noise ratio of the captured image IMG1.

The narrowband light pulses B2 may also be at different wavelengths, e.g. in order to increase an effective spectral width of the illuminating light B2.

Referring to FIG. 9c, forming several narrowband light pulses B2 during a single exposure time Δt_{EX} of the image sensor SEN1 may enable increasing an effective spectral width Δλ_{FWHM, EFF} of the illuminating light (B2), which is used for capturing an image IMG1. Forming several narrowband light pulses B2 during a single exposure time Δt_{EX} of the image sensor SEN1 may enable selecting of an effective spectral width Δλ_{FWHM, EFF} of the illuminating light, which is used for capturing an image IMG1.

Forming several narrowband light pulses B2 during a single exposure time Δt_{EX} of a detector SEN1 of a spectrometer 500 may enable increasing an effective spectral width Δλ_{FWHM, EFF} of the illuminating light (B2), which is used for obtaining a detector signal from an imaging detector SEN1, or from a non-imaging detector SEN1.

Referring to FIG. 9d, the apparatus 500 may be arranged to form narrowband light pulses B2 at a plurality of different wavelengths λ₁, λ₂, λ₃, λ₄ such that the narrowband light pulses B2 together correspond to a spectral energy distribution E_{SPEC}(λ). The generated pulses B2 may together correspond to an arbitrary spectral energy distribution E_{SPEC}(λ). The generated pulses B2 may together correspond e.g. to the spectral energy distribution E_{SPEC}(λ) of sunlight. The generated pulses B2 may together correspond e.g. to the spectral energy distribution E_{SPEC}(λ) of sunlight, in a situation where the sunlight impinges on an object OBJ1 during a time period.

The combined energy E of narrowband light pulses B2 at a given wavelength λ during a predetermined time period may be proportional to the number of the narrowband light pulses B2, which are generated at said wavelength λ during said predetermined time period. For example, the energy E_{λ1} at the first wavelength λ₁ may be proportional to the number of narrowband light pulses B2_{λ1}, which are generated at the first wavelength λ₁ during an exposure time period Δt_{EX} of a sensor SEN1 of the apparatus 500. Forming a first group of narrowband light pulses B2_{λ1} may be started at a first time t₁₀, so as to provide a first energy E_{λ1} at a first wavelength λ₁ (and/or near the first wavelength λ₁). The narrowband light pulses B2_{λ1} of the first group may be formed e.g. during an exposure time period Δt_{EX} of the sensor SEN1. Forming a second group of narrowband light pulses B2_{λ2} may be started at a second time t₂₀, so as to provide a second different energy E_{λ2} at a second different wavelength λ₂ (and/or near the second wavelength λ₂). The number of pulses of the first group may be different from the number of pulses of the second group. Forming a third group of narrowband light pulses B2_{λ3} may be started at a third time t₃₀, so as to provide an energy E_{λ3} at a wavelength λ₃ (and/or near the wavelength λ₃). Forming a fourth group of narrowband light pulses B2_{λ4} may be started at a time t₄₀, so as to provide an energy E_{λ4} at a wavelength λ₄ (and/or near the wavelength λ₄).

The method may optionally comprise providing a blanking time period Δt_{BLANK} between consecutive groups of narrowband light pulses B2_{λ1}, B2_{λ2}. Consequently, exposure times of the same duration Δt_{EX} may be used for the different groups of pulses also in a situation where the groups have different number of pulses. The duration of the blanking time period Δt_{BLANK} may be e.g. greater than two times the average time period (T₀) between consecutive broadband light pulses (B1). The apparatus 500 may be arranged to operate such that narrowband light pulses B2 are not generated during the blanking time period Δt_{BLANK}. For example, the method may comprise triggering broadband light pulses B1 at one or more times where the transmittance peak of the Fabry-Perot interferometer is outside a spectral operating range, which is defined by the one or more optical filters FIL1, FIL2. Consequently, the one or more optical filters FIL1, FIL2 may prevent propagation or forming of the narrowband light pulses B2 during the blanking time period Δt_{BLANK}.

The narrowband light pulses B2_{λ1}, B2_{λ2}, B2_{λ3}, B2_{λ4} at the different wavelengths λ₁, λ₂, λ₃, λ₄ may also be formed as an uninterrupted stream of pulses B2 during a predetermined time period, so as to provide a desired spectral energy distribution E_{SPEC}(λ) on an object OBJ1.

All narrowband light pulses B2_{λ1}, B2_{λ2}, B2_{λ3}, B2_{λ4} at different wavelengths λ₁, λ₂, λ₃, λ₄ may also be formed during the same time period (e.g. Δt_{EX}), so as to represent a desired (arbitrary) spectral energy distribution E_{SPEC}(λ). The apparatus 500 may be arranged to form a plurality of narrowband light pulses B2_{λ1}, B2_{λ2}, B2_{λ3}, B2_{λ4} during a predetermined exposure time period (Δt_{EX}), wherein the wavelengths λ₁, λ₂, λ₃, λ₄ of the narrowband light pulses B2_{λ1}, B2_{λ2}, B2_{λ3}, B2_{λ}4, and the number of the narrowband light pulses B2_{λ1}, B2_{λ2}, B2_{λ3}, B2_{λ4} at each wavelength λ₁, λ₂, λ₃, λ₄ may be selected such that the formed narrowband light pulses B2_{λ1}, B2_{λ2}, B2_{λ3}, B2_{λ4} together provide the desired spectral energy distribution E_{SPEC}(λ). In particular, the pulses may represent the distribution such that the combined energy of narrowband light pulses B2_{λ1} at a first wavelength λ₁ may be different from the combined energy of narrowband light pulses B2_{λ2} at a second wavelength λ₁. The distribution E_{SPEC}(λ) may be a user-selectable distribution. The distribution E_{SPEC}(λ) may represent e.g. the spectral energy distribution of sunlight during the exposure time period Δt_{EX}.

The mirror gap may be modulated sinusoidally e.g. at the frequency f_{SCAN}=10 kHz, the apparatus 500 may be arranged to form a narrowband light pulse B2 e.g. during each half period of the modulating waveform, and the exposure time period Δt_{EX} may be e.g. 500 ms. Consequently, the apparatus may form e.g. 10000 narrowband light pulses B2 during the exposure time period Δt_{EX}, at individually selectable wavelengths. The wavelengths of the pulses and the number of the pulses at each wavelength may be selected to correspond to the desired spectral energy distribution E_{SPEC}(λ), e.g. the spectral energy distribution E_{SPEC}(λ) of sunlight.

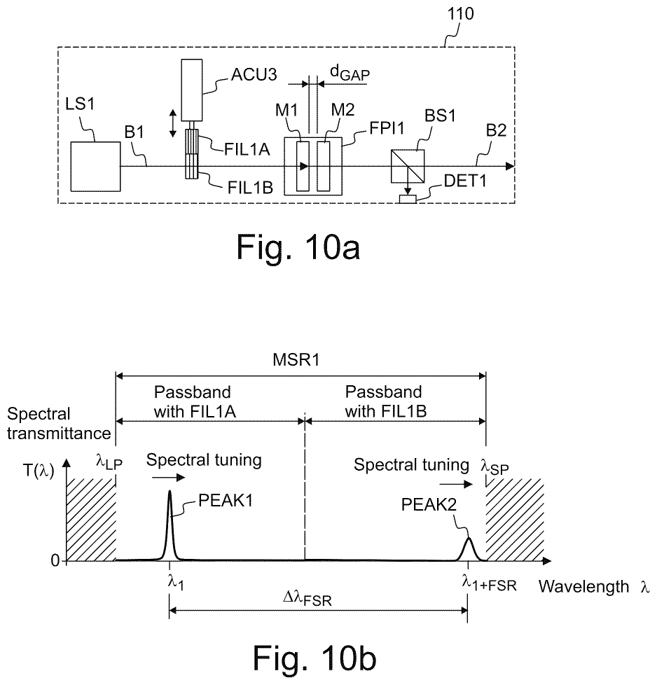

Referring to FIGS. 10a and 10b, the maximum mirror gap of the Fabry-Perot interferometer FPI1 may also be so large that the spectral transmittance function of the Fabry-Perot interferometer FPI1 comprises simultaneously two or more spectral transmittance peaks PEAK1, PEAK2. For example, a first peak PEAK1 may be at the wavelength λ₁, and a second peak may be at the wavelength λ_{1+FSR}, Adjacent peaks are separated by the free spectral range Δλ_{FSR}. The spectral transmittance peaks PEAK1, PEAK2 correspond to different orders of interference. The illuminating unit 110 may optionally comprise an actuator ACU3 and two or more optical filters FIL1A, FIL1B for selecting only one order of interference of the Fabry-Perot interferometer FPI1. The filters FIL1A, FIL1B may be moved by the actuator ACU3, so as to select only one of the spectral transmittance peaks PEAK1, PEAK2. The actuator ACU3 may be arranged to place a first optical filter FIL1A or a second optical filter FIL1B to the optical path of the light pulses B1, B2. The first filter FIL1A may be e.g. an optical low pass filter, and the second filter FIL1B may be e.g. an optical high pass filter. When using a single spectral transmittance peak PEAK1, the formed narrowband light pulse B2 has only one single wavelength (e.g. λ₁), and the captured image IMG1 represents said single wavelength.

For the person skilled in the art, it will be clear that modifications and variations of the devices and methods according to the present invention are perceivable. The figures are schematic. The particular embodiments described above with reference to the accompanying drawings are illustrative only and not meant to limit the scope of the invention, which is defined by the appended claims.

1. An apparatus, comprising:
an illuminating unit to generate light pulses at selectable wavelengths,
a control unit to control operation of the illuminating unit,
wherein the illuminating unit comprises:
a broadband light source to generate broadband light pulses,
a tunable Fabry-Perot interferometer to form narrowband light pulses by filtering the broadband light pulses,
wherein the control unit is arranged to:
modulate the mirror gap of the Fabry-Perot interferometer according to a periodic modulating waveform,
trigger a first broadband light pulse at a first trigger time, so as to form a first narrowband light pulse at a first wavelength,
trigger a second broadband light pulse at a second trigger time, so as to form a second narrowband light pulse at a second wavelength,
wherein the first trigger time is associated with a first value of the modulating waveform,
wherein the second trigger time is associated with a second different value of the modulating waveform,
wherein the broadband light source comprises a seed laser, an optical amplifier, and an optical fiber,
wherein the time interval between the first trigger time and the second trigger time is in the range of 80% to 120% of an average time period between consecutive broadband light pulses.

2. (canceled)

3. The apparatus of claim 1, wherein the average repetition rate of the broadband light pulses is smaller than or equal to two times the modulation frequency of the modulating waveform.

4. The apparatus of claim 1, being arranged to emit a single broadband light pulse during a half period of the modulating waveform.

5. The apparatus of claim 1, wherein the control unit is arranged to modulate the mirror gap as a substantially sinusoidal function, wherein the modulation frequency of the modulating waveform is greater than or equal to 1 kHz, advantageously greater than or equal to 10 kHz, and preferably greater than or equal to 100 kHz.

6. The apparatus of claim 1, wherein the modulation frequency is equal to a positive integer number times half of the average repetition rate of the pulses.

7. The apparatus of claim 1, wherein the broadband light source is arranged to emit broadband light pulses repetitively such that the time interval between each broadband light pulse and the next broadband light pulse is individually adjustable at least in the range of 90% to 110% of the average time period between the broadband light pulses.

8. (canceled)

9. The apparatus of claim 1, comprising a memory for storing a control sequence, wherein the control unit is arranged to determine the first trigger time and the second trigger time according to values of the control sequence.

10. The apparatus of claim 1, wherein the Fabry-Perot interferometer is arranged to operate in a vacuum, wherein the absolute pressure of the vacuum is smaller than 10 kPa.

11. The apparatus of claim 1, wherein the illuminating unit is suitable for illuminating an object with the narrowband light pulses, wherein the apparatus further comprises a sensor for detecting light received from the object, wherein the apparatus is arranged to form two or more narrowband light pulses during an exposure time of the detector.

12. The apparatus of claim 1, wherein the illuminating unit is suitable for illuminating an object with the narrowband light pulses, wherein the apparatus comprises an imaging unit to capture images of the illuminated object.

13. The apparatus of claim 1, comprising a first spectrally selective combination of a calibration light source and a calibration detector, wherein the calibration light source is arranged to provide first calibration light, the calibration detector is arranged to detect first calibration light that has passed through the Fabry-Perot interferometer, wherein the first spectrally selective combination is arranged to form a calibration detector signal, wherein the first spectrally selective combination is arranged to change a state of the calibration detector signal when the wavelength of the spectral transmittance peak of the Fabry-Perot interferometer becomes higher or lower than a first predetermined calibration wavelength.

14. A method for forming light pulses at selectable wavelengths, the method comprising:
generating broadband light pulses by using a broadband light source,
forming narrowband light pulses by filtering the broadband light pulses with a tunable Fabry-Perot interferometer,
modulating the mirror gap of the Fabry-Perot interferometer according to a periodic modulating waveform,
triggering a first broadband light pulse at a first trigger time, so as to form a first narrowband light pulse at a first wavelength,
triggering a second broadband light pulse at a second trigger time), so as to form a second narrowband light pulse at a second wavelength,
wherein the first trigger time is associated with a first value of the modulating waveform,
wherein the second trigger time (t₂) is associated with a second different value of the modulating waveform,
wherein the broadband light source comprises a seed laser, and optical amplifier, and an optical fiber,
wherein the time interval between the first trigger time and the second trigger time is in the range of 80% to 120% of an average time period between consecutive broadband light pulses.

15. The method of claim 14, wherein the average repetition rate of the broadband light pulses is smaller than or equal to two times the frequency of the modulating waveform.
